(19) United States
(12) Patent Application Publication
(10) Pub. No.: US 2019/0217336 A1
(43) Pub. Date: Jul. 18, 2019

(54) METHODS FOR FORMING STAINLESS STEEL PARTS

(71) Applicant: Arcanum Alloys, Inc., Sunnyvale, CA (US)

(72) Inventors: Daniel E. Bullard, Sunnyvale, CA (US); David Keifer, Sunnyvale, CA (US); Zachary M. Detweiler, Sunnyvale, CA (US)

(21) Appl. No.: 16/245,729

(22) Filed: Jan. 11, 2019

Related U.S. Application Data
(63) Continuation of application No. PCT/US2017/042012, filed on Jul. 13, 2017.
(60) Provisional application No. 62/362,526, filed on Jul. 14, 2016.
(60) Provisional application No. 62/439,393, filed on Dec. 27, 2016.

(51) Int. Cl. B05D 5/06; B05D 1/28; B05D 3/02; B05D 7/14

(52) U.S. Cl. CPC B05D 5/061; B05D 7/14; B05D 3/0254; B05D 1/28

(57) ABSTRACT

The present disclosure provides methods forming a stainless steel part. A method for forming a stainless steel part may comprise providing a substrate comprising stainless steel and at least one depression that projects into at least a portion of the substrate. The at least one depression may be in accordance with a depression pattern. A coating material may be provided on at least a portion of the surface having at least one depression.

### CROSS-REFERENCE

This application is a continuation of International Patent Application No. PCT/US2017/042012, filed Jul. 13, 2017, which claims priority to U.S. Provisional Patent Application No. 62/362,526, filed Jul. 14, 2016, and U.S. Provisional Patent Application No. 62/439,393, filed Dec. 27, 2016, each of which are entirely incorporated herein by reference.

### BACKGROUND

Steel can be an alloy of iron and other elements, including carbon. Without limitation, the following elements can be present in steel: carbon, manganese, phosphorus, sulfur, silicon, and traces of oxygen, nitrogen, and aluminum. Polished stainless steel can be utilized in many industries, including household appliances, such as refrigerators, dishwashers, baking ovens; and laundry machines. There can be different grades and surface finishes of stainless steel to suit a given environment. When polished, stainless steel can have an aesthetically pleasing surface appearance. It is known that polished coatings can give an attractive surface appearance to consumer related products.

### SUMMARY

Recognized herein are various limitations associated with forming stainless steel substrates. For instance, as conventional paints are applied onto a polished stainless steel substrate, the pigments can fill into the depressions and slightly reduce the specular and diffuse reflection of the substrate. Accordingly, recognized herein is the need for methods to generate stainless steel parts with given or predetermined finishes, such as color patterns. For example, a stainless steel substrate can be coated with a semitransparent paint to provide a relatively small amount of color to the end product hut not mute the sparkle of the polished surface.

The present disclosure provides systems and methods for polishing or repolishing metal substrates, such as stainless steel substrates. This may be used to yield a metal part, such as a stainless steel part, having a given or predetermined finish, such as a color pattern.

In an aspect, the present disclosure provides a method for forming a stainless steel part, comprising (a) providing a substrate comprising stainless steel adjacent to a support, wherein said substrate comprises at least one depression in accordance with a depression pattern, which at least one depression projects into at least a portion of said substrate from a surface of said substrate; and (b) providing a coating material on at least a portion of said surface having said at least one depression, wherein said coating provides an average roughness (Rₐ) of about 7 micro inches (μin) to 110 μin as measured by profilometry and at least any two of (i) a lightness from about 5 to 100 at an incident angle to brush pattern of 90°, (ii) a sparkle intensity from about 1 to 15 at an incident angle to brush pattern of 90°, (iii) a sparkle area from about 5 to 60 at an incident angle to brush pattern of 90°, and (iv) a graininess level from about 2 to 10 as measured by spectrophotometry at a temperature of about 25° C. In some embodiments, the surface is an exposed surface.

In some embodiments, (a) comprises generating at least one depression in the substrate in accordance with the depression pattern. In some embodiments, (b) comprises depositing said coating material on said at least said portion of said surface having said at least one depression. In some embodiments, the method further comprises (c) curing the at least the portion of the surface having the coating material deposited thereon, to provide the coating on the surface having a roughness from Ra 7 μin to 110 μin. In some embodiments, the method further comprises subsequent (b), polishing the at least the portion of the surface to remove the coating material from the at least the portion of the surface. In some embodiments, the coating provides at least any three of (i)-(iv). In some embodiments, the substrate comprises an outer stainless steel layer diffusion bonded to an underlying layer. In some embodiments, the underlying layer comprises carbon. In some embodiments, the average roughness is from about 30 μin to 110 μin. In some embodiments, the coating provides a lightness from about 30 to 80 at the incident angle to brush pattern of 90°. In some embodiments, the coating provides a sparkle intensity from about 5 to 15 at the incident angle to brush pattern of 90°. In some embodiments, the coating provides a sparkle area from about 20 to 60 at the incident angle to brush pattern of 90°.

In another aspect, the present disclosure provides a stainless steel part, comprising a substrate comprising stainless steel, wherein the substrate comprises at least one depression in accordance with a depression pattern, which at least one depression projects into at least a portion of the substrate from a surface of the substrate; and a coating material on at least a portion of the surface having at least one depression, wherein the coating provides an average roughness (Rₐ) of about 7 micro inches (μin) to 110 μin as measured by profilometry and at least any two of (i) a lightness from about 5 to 100 at an incident angle to brush pattern of 90°, (ii) a sparkle intensity from about 1 to 15 at an incident angle to brush pattern of 90°, (iii) a sparkle area from about 5 to 60 at an incident angle to brush pattern of 90°, and (iv) a graininess level from about 2 to 10 as measured by spectrophotometry at a temperature of about 25° C. In some embodiments, the surface is an exposed surface.

In some embodiments, the average roughness is from about 30 μin to 110 μin. In some embodiments, the coating provides a lightness from about 30 to 80 at the incident angle to brush pattern of 90°. In some embodiments, the coating provides a sparkle intensity from about 5 to 15 at the incident angle to brush pattern of 90°. In some embodiments, the coating provides a sparkle area from about 20 to 60 at the incident angle to brush pattern of 90°. In some embodiments, the coating provides at least any three of (i)-(iv). In some embodiments, the substrate comprises an outer stainless steel layer diffusion bonded to an underlying layer. In some embodiments, the underlying layer comprises carbon.

In another aspect, the present disclosure provides a method for coating a surface of a stainless steel substrate, comprising (a) providing the stainless steel substrate having the surface adjacent to a support; (b) generating at least one depression in the stainless steel substrate in accordance with a depression pattern, which at least one depression projects into at least a portion of the stainless steel substrate from the surface; (c) depositing a coating material on at least portion of the surface having at least one depression; and (d) curing at least the portion of the surface having the coating material deposited thereon, to provide a coating on the surface having a roughness (e.g., average roughness, Rₐ) of 7 micro inches (μin) to 110 μin.

In some embodiments, the stainless steel substrate comprises elements selected from the group consisting of carbon, silicon, manganese, phosphorus, sulfur, nickel, chromium, molybdenum, copper, and nitrogen. In some embodiments, the stainless steel substrate has a grade that is selected from the group consisting of martensitic grade, duplex grade, ferritic grade, austenitic ferritic grade, austenitic grade, and precipitation hardening grade.

In some embodiments, at least one depression projects through the stainless steel substrate. In some embodiments, at least one depression yields a texturized stainless steel surface. In some embodiments, texturized stainless steel surface has an average roughness (Rₐ) of at least about 30 μin. In some embodiments, at least one depression is generated by abrasive blasting, mechanical abrasion, and final cleaning. In some embodiments, the depression pattern is selected from the group consisting of concentric ordered layouts, random swirls, random orbitals, raised circles, raised squares, random scratches, angel hair, text, company logos, and line work, or any combination thereof.

In some embodiments, the coating material partially fills the at least one depression. In some embodiments, the coating material is deposited by applying a liquid comprising the coating material to the surface. In some embodiments, the coating material is selected from the group consisting of an ink, penetrating dye, semitransparent paint, stain, and patina. In some embodiments, the coating material is semitransparent paint. In some embodiments, the semitransparent paint includes urethane. In some embodiments, the coating has a dry film thickness of 5 mg/3 in² to 40 mg/3 in². In some embodiments, the coating includes a prime layer having a thickness of at least 5 mg/3 in². In some embodiments, the coating includes an outer layer having a thickness of at least about 10 mg/3 in².

In some embodiments, the curing comprises subjecting the surface to thermal energy. In some embodiments, the curing comprises subjecting at least a portion of the surface to annealing over an annealing time period of at most about 60 second. In some embodiments, the annealing time period is at most about 45 seconds. In some embodiments, the annealing time period is at least about 30 seconds. In some embodiments, the annealing is at a temperature of at least about 100° F. In some embodiments, the curing comprises air drying. In some embodiments, the coating material is cured such that the coating material is insoluble in water, solvent(s), or household cleaning agent(s) over the acceptable periods of time for the final application.

In some embodiments, the subsequent (d), at least a portion of the surface is polished to remove the coating material from at least a portion of the surface. In some embodiments, the polishing comprises use of a drag pad or a buffing wheel. In some embodiments, the polishing comprises use of a drag pad. In some embodiments, the polishing comprises polishing in a cut motion or a color motion. In some embodiments, the polishing removes the coating material from a location above the depression and above a plane of the surface. In some embodiments, the polishing exposes metal above a plane of at least one depression.

In some embodiments, the polishing yields a predetermined appearance. In some embodiments, the appearance is a metallic appearance. In some embodiments, the surface comprises one or more defects and wherein the polishing seals the one or more defects. In some embodiments, the coating on the surface has a horizontal or a vertical brush pattern. In some embodiments, a change in horizontal to vertical brush pattern yields a reflectivity change from light to dark. In some embodiments, the reflectivity change occurs in florescent or natural light. In some embodiments, the brush pattern is observable in florescent or natural light. In some embodiments, the brush pattern is observable at a range of 5 feet to 35 feet from the surface. In some embodiments, the coating on the surface has a natural flop.

Another aspect provides a non-transitory computer readable medium comprising machine executable code that, upon execution by one or more computer processors, implements any of the methods above or elsewhere herein.

In another aspect, the present disclosure provides a system for coating a surface of a stainless steel substrate, comprising a support configured to hold the stainless steel substrate having the surface; and a controller comprising one or more computer processors that are individually or collectively programmed to (i) generate at least one depression in the stainless steel substrate in accordance with a depression pattern, which at least one depression projects into at least a portion of the stainless steel substrate from the surface; (ii) deposit a coating material on at least portion of the surface having the at least one depression; and (iii) cure at least the portion of the surface having the coating material deposited thereon, to provide a coating on the surface having a roughness (e.g., average roughness, Rₐ) of 7 μin to 110 μin.

In some embodiments, one or more computer processors are individually or collectively programmed to cure at least the portion of the surface by subjecting at least the portion of the surface to annealing over an annealing time period of at most about 60 second. In some embodiments, the annealing time period is at most about 45 seconds. In some embodiments, the annealing time period is at most about 30 seconds. In some embodiments, the annealing is at a temperature of at least about 100° F.

In some embodiments, one or more computer processors are individually or collectively programmed to direct polishing of at least the portion of the surface to remove the coating material from at least a portion of the surface.

Methods provided herein may be used to form parts, such as metal parts, having various finish configurations, such as texture and/or color configurations. In some examples, methods of the present disclosure are used to form stainless steel parts having various color configurations (e.g., black stainless steel). Such color configurations may be a single color or multiple colors.

Methods provided herein are at least in part based on the unexpected realization that a finished part, such as stainless steel part, may be treated to form one or more depressions, and subsequently coated with a coating material to impart a given finish configurations, such as a texture and/or color configuration. Methods provided herein may be used to impart a given color configuration to a substrate, such as, for example, used to generate black stainless steel. As another example, methods provided herein may be used to impart a given texture to a substrate, such as a rough texture.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a method for forming a metal surface having a shape or color configuration;

FIG. 2 schematically illustrates three panels: a scratched substrate with highs and lows, a coated substrate, and a polished substrate with color removed from the high surfaces;

FIG. 3 illustrates the spectrophotometer measurements of lightness at an incident angle to brush pattern of 0°, 45°, and 90°;

FIG. 4 illustrates the spectrophotometer measurements of sparkle intensity at an incident angle to brush pattern of 0°, 45°, and 90°;

FIG. 5 illustrates the spectrophotometer measurements of sparkle area at an incident angle to brush pattern of 0°, 45°, and 90°;

FIG. 6 illustrates the sparkle grade for three samples with sample 3 showing the highest sparkle grade values at angles of reflection of 15°, 45°, and 75°;

FIG. 7 illustrates the spectrophotometer measurements of graininess at an incident angle to brush pattern of 0°, 45°, and 90°; and

FIG. 8 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “substrate,” as used herein, generally refers to all or a portion of a surface onto which coating layer can be applied. The substrate can be a single piece or multi-piece material. The substrate can have a single layer or a plurality of layers, such as a plurality of metal layers. The substrate can be formed of one or more metals, such as nickel, chromium, gold, silver, platinum, iron, titanium, or aluminum. In some examples, the substrate is formed of stainless steel. The substrate may be in various shapes and sizes. In an example, the substrate is a sheet. In another example, the substrate is a tube.

In some examples, the substrate is stainless steel. Examples of the stainless steel substrate, as well as methods and systems for forming the stainless steel substrate, are disclosed in U.S. Pat. Nos. 8,608,875, 8,628,861, 8,784,997, 8,790,790, 8,795,447, 8,557,397, 9,333,727, and U.S. Patent Publication No. 2016/0230284, each of which is entirely incorporated herein by reference.

The term “pattern,” as used herein, generally refers to a design generated by at least one depression in the stainless steel substrate. The design may be in accordance with a predetermined configuration. Such depression patterns may include, for example, concentric ordered layouts, random swirls, random orbitals, raised circles, raised squares, random scratches, angel hair, text, company logos, and line work, or any combination thereof.

The term “coating,” as used herein, generally refers to one or more layers that provide a colored or clear appearance to an underlying or adjacent substrate. The one or more layers can be an ink, penetrating dye, semitransparent paint, stain, or patina. In some examples, the coating may be or include alkyds, acrylated rubbers, chlorinated rubbers, acrylic, zinc rich, epoxy, urethane, polyurethane, oxirane ester paints, stoving enamels, vinyl, bituminous, intumescent, silicone, organic silicate, and/or inorganic silicate.

The term “polymer,” as used herein, generally refers to copolymers, homopolymers, and oligomers.

The terms “cure” and “cured,” as used herein, generally refer to treating or processing a material layer or surface. Curing may include annealing or exposure to a stimulus, such as an energy beam or a chemical curing agent. For example, curing may include polymerizing and/or cross-linking. Curing of a polymerizable composition may include subjecting the polymerizable composition to curing conditions, such as, but not limited to, thermal, catalytic, electron beam, chemical free-radical initiation, and/or photo-initiation, such as by exposure to ultraviolet light or other actinic radiation. Curing may lead to the reaction of the reactive functional groups of the composition, and resulting in polymerization and formation of a polymerizate. When a polymerizable composition or substrate is subjected to curing conditions, following polymerization and after reaction of most of the reactive groups occurs, the rate of reaction of the remaining unreacted reactive groups may become progressively slower. The polymerizable composition can be subjected to curing conditions until it is at least partially cured. The substrate may be partially cured. Partial curing may include subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The present disclosure provides methods and systems to produce a metal surface, such as a stainless steel surface, having a shape or color configuration. Such methods may include polishing or repolishing the surface. The shape or color configuration may be predetermined, such as in accordance with a color pattern. In some examples, methods and systems of the present disclosure are used to prepare a stainless steel surface having a color pattern.

### Methods for Forming Parts

The present disclosure provides methods for forming a part, such as a stainless steel part, that may be used in a variety of applications. The parts formed according to methods of the present disclosure may have various form factors, such as sheets, panels, wires, tubes, rods, strips, foils, blocks, pipes, coils, bars, plates, and rings. Such parts may be used in various applications, such as parts as components of appliances (e.g., refrigerators or ovens). The components may be viewable by a user of such applicants. The applications may include surface-finished railings, covers, formwork panels, kitchen furniture, housing of kitchen utensils, cooker hood housing, sanitary equipment, trim elements and housings and enclosures are manufactured with a sophisticated design. Such substrates may also include cold-rolled steel sheets, galvanized steel sheets, zinc alloy-plated steel sheets, stainless steel sheets, tinned steel sheets and other steel sheets, aluminum sheets, aluminum alloy sheets, magnesium sheets, magnesium alloy sheets, molded plastic materials, plastic foams and other plastic substrates, or glass substrates. Further, the stainless steel part may be formed of a stainless steel substrate that may be selected from various grades of stainless steel. Such grades can include, for example, ferritic steel, austenitic ferritic grade, austenitic steel, martensitic steel, duplex steel, or precipitation hardening steel. Also, the stainless steel substrate can contain at least one elemental species. The elemental species in the stainless steel substrate can be carbon, silicon, manganese, phosphorus, sulfur, nickel, chromium, molybdenum, copper, and nitrogen or combinations thereof.

In an aspect, the present disclosure provides a method for coating a surface of a substrate, such as a metal substrate. The substrate may be formed of a single layer or material, or a plurality of layers or materials. The method may comprise providing the substrate adjacent to a support. The substrate may include a surface. The surface may be an exposed surface (e.g., capable of being processed from a gas or liquid phase when the substrate is adjacent to the support). Next, at least one depression may be generated in the substrate in accordance with a depression pattern. The at least one depression may be generated in the surface. The depression pattern may include at least one depression that may project into at least a portion of the substrate from the surface. Next, a coating material may be deposited on at least portion of the surface having the at least one depression. The at least the portion of the surface having the coating material deposited thereon may then be cured, such as by annealing at an annealing temperature or within a temperature range for an annealing period of time. The process of curing may provide a coating on the surface having a roughness of 10 micro inches (μin) to 200 μin, or 10 μin to 190 μin, or 10 μin to 180 μin, or 10 μin to 170 μin, or 10 μin to 160 μin, or 10 μin to 150 μin, or 10 μin to 140 μin, or 10 μin to 130 μin, or 10 μin to 120 μin, or 10 μin to 110 μin, or 10 μin to 100 μin, or 10 μin to 90 μin, or 10 μin to 80 μin, or 10 μin to 70 μin, or 10 μin to 60 μin, or 10 μin to 50 μin, or 10 μin to 40 μin, or 10 μin to 30 μin, or 10 μin to 20 μin. In some examples, the surface has a roughness of at least about 5 μin, at least about 10 μin, at least about 20 μin, at least about 30 μin, at least about 40 μin, at least about 50 μin, at least about 60 μin, at least about 70 μin, at least about 80 μin, at least about 90 μin, at least about 100 μin, at least about 110 μin, at least about 120 μin, or at least about 130 μin.

The substrate may include one or more metals. In some cases, the substrate includes a plurality of metals in alloy form.

For example, a substrate may be a metal substrate, such as a stainless steel substrate. The stainless steel substrate may be formed of stainless steel. The stainless steel may include chromium and nickel. In some examples, a metal substrate may comprise one or more elements selected from the group consisting of carbon, silicon, manganese, phosphorus, sulfur, nickel, chromium, molybdenum, copper, and nitrogen. The stainless steel substrate may be of various grades. In some examples, the stainless steel substrate has a grade that is selected from the group consisting of martensitic grade, ferritic grade, austenitic ferritic grade, austenitic grade, and precipitation hardening grade.

The substrate may contain at least one depression projecting through the substrate. The substrate can be a metal substrate, such as stainless steel. The projection may project through at least a portion of the substrate, such as from a surface of the substrate and into a bulk of the substrate. At least one depression may yield a texturized surface on the substrate. The texturized surface may have an average roughness (Rₐ) of at least about 5 μin, at least about 10 μin, at least about 20 μin, at least about 30 μin, at least about 40 μin, at least about 50 μin, at least about 60 μin, at least about 70 μin, at least about 80 μin, at least about 90 μin, at least about 100 μin, at least about 110 μin, at least about 120 μin, or at least about 130 On. At least one depression is generated by abrasive blasting, mechanical abrasion, and final cleaning.

Measurements for roughness may comprise amplitude parameters, spatial parameters, hybrid parameters, and functional parameters. Amplitude parameters may include total height of the profile (Rt), maximum profile peak height (Rp), maximum profile valley depth (Rv), maximum height of the profile (Rmax, Ry, Rz1max, or Rz), arithmetic mean deviation of the assessed profile (Ra), root mean square deviation of the assessed profile (Rq), skewness of the assessed profile (Rsk), kurtosis of the assessed profile (Rku), and mean height of profile elements (Rc). Spatial parameters may comprise mean spacing of profile elements (Rsm). Hybrid parameters may comprise root mean square slope of the assessed profile (Rdq) and peak count number (Rpc). The functional parameters may comprise material ratio at a given depth (Rmr) and profile section height between material ratios (Rdc). Other parameters can comprise core roughness depth (Rk), reduced peak height (Rpk), reduced valley depth (Rvk), plateau root mean square roughness (Rpq), valley root mean square roughness (Rvq), material root at plateau-to-valley transition (Rmq). The parameters can move directionally together. For example as Rz and Rmax increases in value, Ra increases in value.

The depression pattern may be selected from the group consisting of concentric ordered layouts, random swirls, random orbitals, raised circles, raised squares, random scratches, angel hair, text, company logos, and line work, or any combination thereof.

The coating material may be deposited by applying a liquid comprising the coating material to the substrate surface. The coating material may partially fill at least one depression. The coating material is selected from the group consisting of an ink, penetrating dye, semitransparent paint, stain, and patina. The coating material may be semitransparent paint. The semitransparent paint may include urethane. A thin film of paint may be applied. The standard paints may have volume between about 40% and 80%, or 40% and 70%, 40% and 60%, or 40% and 50% of solids. For example, the volume may be at least about 10%, at least about 20%, at least about 30%, at least about 40%, at least about 50%, at least about 60%, at least about 70%, or at least about 80%. Another thin film of paint may be applied onto the coat of standard paints. The thin film may be about ¼ to ⅓, or ¼ to ½, or ¼ to ¾, or ¼ to 4/4 of the amount applied using standard paints. For example, the thin film may be at most about ¼, at most about ⅓, or at most about ½ of the amount applied using standard paints. The coating may have a dry film thickness (DFT) of 5 milligram/3 square inches (5 mg/3 in²) to 50 mg/3 in², 5 mg/3 in² to 45 mg/3 in², 5 mg/3 in² to 40 mg/3 in², 5 mg/3 in² to 35 mg/3 in², 5 mg/3 in² to 30 mg/3 in², 5 mg/3 in² to 25 mg/3 in², 5 mg/3 in² to 20 mg/3 in², 5 mg/3 in² to 15 mg/3 in², 5 mg/3 in² to 10 mg/3 in². For example, the DFT may be at least about 1 mg/3 in², 5 mg/3 in², 10 mg/3 in², 15 mg/3 in², 20 mg/3 in², 25 mg/3 in², 30 mg/3 in², 35 mg/3 in², 40 mg/3 in², 45 mg/3 in², or 50 mg/3 in². The coating may have a prime and an outer layer. The prime layer may have a thickness of at least about 1 mg/3 in², 5 mg/3 in², 10 mg/3 in², 15 mg/3 in², 20 mg/3 in², 25 mg/3 in², 30 mg/3 in², 35 mg/3 in², 40 mg/3 in², 45 mg/3 in², or 50 mg/3 in². The outer layer may have a thickness of at least about 5 mg/3 in², 10 mg/3 in², 15 mg/3 in², 20 mg/3 in², 25 mg/3 in², 30 mg/3 in², 35 mg/3 in², 40 mg/3 in², 45 mg/3 in², or 50 mg/3 in².

Curing the metal substrate may comprise subjecting the surface to annealing. The annealing may include directing thermal energy at the surface. The curing may comprise subjecting at least the portion of the substrate surface to annealing over an annealing time period of at most about 5 seconds, 15 seconds, 20 seconds, 25 seconds, 30 seconds, 35 seconds, 40 seconds, 45 seconds, 50 seconds, 55 seconds, 60 seconds, 65 seconds, or 70 seconds. The annealing temperature or part metal temperature (PMT) may be at least about 50 Fahrenheit (° F.), 100° F., 150° F., 200° F., 300° F., 400° F., 500° F., 600° F., 700° F., 800° F., 900° F. or 1000° F. The substrate may be cured by air drying. The coating material may be cured such that the coating material is insoluble in water, solvent(s), or household cleaning agent(s) over the acceptable periods of time for the final application (e.g. number of rubs with methylethylketone for paint on appliances).

A polishing operation may follow the coating operation. Polishing at least a portion of the surface may remove the coating material from at least a portion of the surface. Polishing of the coated substrate may comprise use of an abrasive agent or material, such as a drag pad or a buffing wheel. The polishing may comprise use of a drag pad. The polishing may comprise polishing in a cut motion or a color motion. The polishing may remove the coating material from a location above the depression and above a plane of the surface. The polishing may expose the metal above a plane of at least one depression. The polishing may yield a predetermined appearance. The predetermined appearance may be a metallic appearance. The surface may comprise one or more defects and the polishing seals one or more defects.

The coating on the surface may have a horizontal or a vertical brush pattern. The change in horizontal to vertical brush pattern may yield a reflectivity change from light to dark. The reflectivity change can occur in florescent or natural light. The brush pattern can be observed in florescent or natural light. The brush pattern can be observed at a range of 5 feet to 45 feet, or 5 ft to 40 ft, or 5 ft to 35 ft, or 5 ft to 30 ft, or 5 ft to 25 ft, or 5 ft to 20 ft, or 5 ft to 15 ft, or 5 ft to 10 ft from the surface. For example, the brush pattern may be observed at a range of at least about 1 feet, 5 feet, 10 feet, 15 feet, 20 feet, 25 feet, 30 feet, 35 feet, 40 feet, or 45 feet. The coating on the surface may have a natural flop.

In another aspect, the present disclosure provides a system for coating a surface of a stainless steel substrate, comprising: a support configured to hold the stainless steel substrate having the surface and a controller comprising one or more computer processors that are individually or collectively programmed to (i) generate at least one depression in the stainless steel substrate in accordance with a depression pattern, which at least one depression projects into at least a portion of the stainless steel substrate from the surface; (ii) deposit a coating material on at least portion of the surface having the at least one depression; and (iii) cure at least the portion of the surface having the coating material deposited thereon, to provide a coating on the surface having a roughness of 10 μin to 200 μin, or 10 μin to 190 μin, or 10 μin to 180 μin, or 10 μin to 170 μin, or 10 μin to 160 μin, or 10 μin to 150 μin, or 10 μin to 140 μin, or 10 μin to 130 μin, or 10 μin to 120 μin, or 10 μin to 110 μin, or 10 μin to 100 μin, or 10 μin to 90 μin, or 10 μin to 80 μin, or 10 μin to 70 μin, or 10 μin to 60 μin, or 10 μin to 50 μin, or 10 μin to 40 μin, or 10 μin to 30 μin, or 10 μin to 20 μin, or between 70 μin and 120 μin. For example, the surface may have a roughness of at least about 5 μin, at least about 10 μin, at least about 20 μin, at least about 30 μin, at least about 40 μin, at least about 50 μin, at least about 60 μin, at least about 70 μin, at least about 80 μin, at least about 90 μin, at least about 100 μin, at least about 110 μin, at least about 120 μin, or at least about 130 μin. In the system, one or more computer processors may be individually or collectively programmed to cure at least a portion of the surface by subjecting at least the portion of the surface to annealing over an annealing time period of at most about 60 second. The annealing time period may be at most about 10 seconds, at most about 20 seconds, at most about 30 seconds, at most about 40 seconds, at most about 50 seconds, at most about 60 seconds, at most about 70 seconds, at most about 80 seconds, at most about 90 seconds, at most about 2 minutes, or at most about 5 minutes.

The annealing temperature may be at least about 50° F., 100° F., 150° F., 200° F., 300° F., 400° F., 500° F., 600° F., 700° F., 800° F., 900° F. or 1000° F. In the system, one or more computer processors may be individually or collectively programmed to direct polishing of at least a portion of the surface to remove the coating material from at least a portion of the surface.

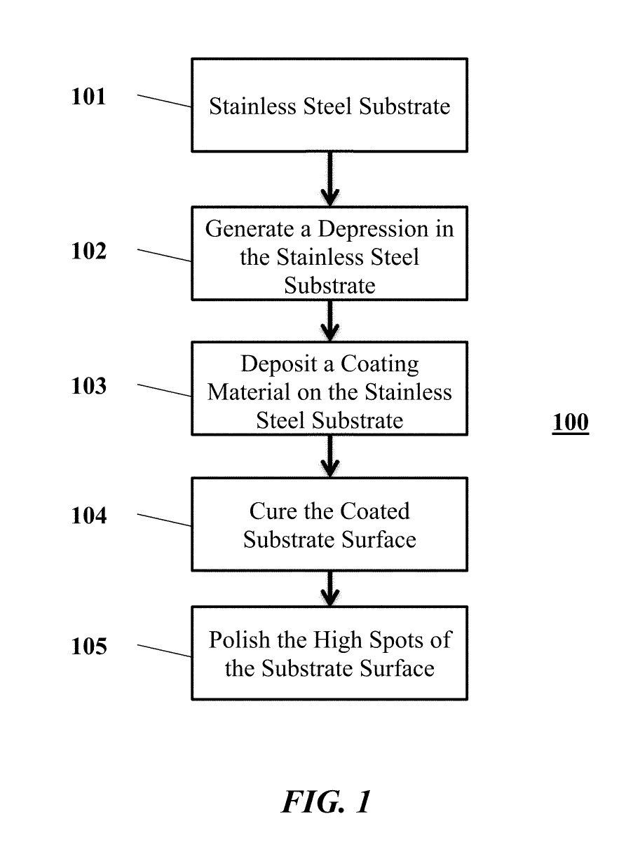

FIG. 1 illustrates a method 100 for forming a part having a shape or color configuration. In the illustrated example, the part is a stainless steel part; however, the method 100 may be applied to other materials. In operation 101, a stainless steel substrate may be provided adjacent to a support. The stainless steel substrate may have a surface. The surface may be an exposed surface. The stainless steel substrate may be provided on a platform or susceptor.

Next, in operation 102, the stainless steel substrate may be pre-treated to form one or more depression patterns, shape a surface, or remove surface contaminants. Pre-treatment may include such techniques as embossing or coining. The one or more depression patterns may generate, from the surface, a texturized surface with a roughness Ra of at least about 10 μin, 20 μin, 30 μin, 40 μin, 50 μin, 60 μin, 70 μin, 80 μin, 90 μin, 100 μin, or 200 μin. In operation 103, a coating material may be deposited onto the texturized surface. The one or more depression patterns may include one or more individual depressions. Such one or more individual depressions may be formed by imparting a depression in the surface at a pressure and mechanical speed that is sufficient to create at least one depression pattern.

In operation 103, paint with a DFT of about 0.0001 inches (in) and 0.002 in, about 0.0001 in and 0.001 in, about 0.0002 in and 0.002 in, about 0.0003 in and 0.002 in, about 0.0004 in and 0.002 in, about 0.0005 in and 0.002 in, about 0.0006 in and 0.002 in, about 0.0007 in and 0.002 in, about 0.0008 in and 0.002 in, about 0.0009 in and 0.002 in, about 0.001 in and 0.002 in, about 0.0015 in to 0.002 in may be deposited on the texturized surface. The DFT may be dependent upon the volume of solids in the paint system. In some cases, the DFT may be at most about 0.05 mils, 0.10 mils, 0.15 mils, 0.20 mils, 0.25 mils, 0.30 mils, 0.35 mils, or 0.40 mils.

Next, in operation 104, the coated portion of the surface or the stainless steel substrate may be cured by annealing at an annealing temperature for an annealing period of time. The coated portion of the surface or the stainless steel substrate may be annealed by heating the coated portion of the surface or the stainless steel substrate, such as by convective heating, resistive heating or radiative heating.

The annealing temperature may be at least about 50° F., 100° F., 150° F., 200° F., 300° F., 400° F., 500° F., 600° F., 700° F., 800° F., 900° F. or 1000° F. The annealing period of time may be at most about 5 seconds, 15 seconds, 20 seconds, 25 seconds, 30 seconds, 35 seconds, 40 seconds, 45 seconds, 50 seconds, 55 seconds, 60 seconds, 65 seconds, 70 seconds, 90 seconds, 2 minutes, 5 minutes, 10 minutes, or 15 minutes. For example, the time may be at most about 5 seconds, 15 seconds, 20 seconds, 25 seconds, 30 seconds, 35 seconds, 40 seconds, 45 seconds, 50 seconds, 55 seconds, 60 seconds, 65 seconds, or 70 seconds at least about 100° F., 150° F., 200° F., 300° F., 400° F., 500° F., 600° F., 700° F., 800° F., 900° F. or 1000° F. Alternatively, the annealing time may be at least about 1 second, 10 seconds, 30 seconds, 60 seconds, 2 minutes, 3 minutes, 4 minutes, 5 minutes, 10 minutes, 15 minutes, 30 minutes, 1 hour, 12 hours, or 1 day.

In some cases, substrates with post-coating applications may be fully formed or shaped with a surface roughness between 10 μin to 200 μin, or 10 μin to 190 μin, or 10 μin to 180 μin, or 10 μin to 170 μin, or 10 μin to 160 μin, or 10 μin to 150 μin, or 10 μin to 140 μin, or 10 μin to 130 μin, or 10 μin to 120 μin, or 10 μin to 110 μin, or 10 μin to 100 μin, or 10 μin to 90 μin, or 10 μin to 80 μin, or 10 μin to 70 μin, or 10 μin to 60 μin, or 10 μin to 50 μin, or 10 μin to 40 μin, or 10 μin to 30 μin, or 10 μin to 20 μin, or between 70 μin and 120 μin, or between 70 μin and 80 μin. The fully formed or shaped substrate may then be coated with a variety of coatings according to the methods disclosed herein and cured to provide an aesthetic.

In some cases, in an optional subsequent operation 105, the high spots of the depression pattern are polished to reveal the sparkle of the stainless steel. The high spots may be characterized by an excess of color. The high spots may be polished with a rotary wire brush or finishing with abrasive pads, such as a drag pad.

Annealing may be done with the aid of an energy source. Energy may be transferred to the surface or coating via radiative energy transfer (e.g., through infrared radiation), convective energy transfer (e.g., using a hot fluid), or conductive energy transfer (e.g., using resistive heating). As an alternative, annealing may be performed in a controlled or uncontrolled environment, such as by permitting the surface to anneal in air or under an inert atmosphere.

A metal substrate may be subjected to surface pre-treatment. This operation may be performed in order to maximize bonding between the substrate surface and the coat layer. A stainless steel substrate may be prepared by cleaning the surface to remove contaminants. The contaminants may be organic or inorganic. The contaminants can include grease, rust, paint, oil, moisture, and scale. The cleaning process may include vapor degreasing, solvent cleaning, baking, ultrasonic cleaning, or dry abrasive blasting. In addition, the solvent may include alcohol, acetone, or aqueous washer solutions with acetic acid. The substrate cleaning tools can include Henkel cleaning products and spinning brushes. The Henkel cleaning products may include alkaline cleaner, neutral cleaner, lubricant Acheson, and corrosion inhibitor. In addition, the surface pre-treatment may include phosphate or chromate treatments to improve coating adhesion. For example, the typical substrate cleaning agents may be found on continuous sheet coating lines.

After cleaning the metal substrate, a polishing tool may impart a depression in the surface at a pressure and mechanical speed that is sufficient to create at least one depression pattern. This may be performed by directing abrasive particles at a smooth surface. Upon contact, a given particle may impart one or more depressions into the surface. In some cases, the particles impart depressions into the surface. The depressions may be regular or irregular. Parameters that affect the degree of deformation may include density, hardness of the particles, size, speed, angle, size, and/or specific gravity. The depression patterns can be formed by abrasive blasting, mechanical abrasion (e.g., hand abrasion), and final cleaning. The final cleaning may be a final cleaning operation before formation of a finished part.

Abrasive blasting may be selected from the group consisting of wet abrasive blasting, bead blasting, wheel blasting, hydro-blasting, micro-abrasive blasting, automated blasting, dry ice blasting, and bristle blasting. In some examples, abrasive blasting occurs by accelerating a grit of sand sized particles with compressed air to form a stream of high velocity non-metallic abrasive particles to roughen a smooth surface. The pressure of abrasive blasting may be between about 20 pounds per square inch (psi) and 105 psi, or 20 psi and 100 psi, or 20 psi and 95 psi, or 20 psi and 90 psi, or 20 psi and 85 psi, or 20 psi and 80 psi, or 20 psi and 75 psi, or 20 psi and 70 psi, or 20 psi and 65 psi, or 20 psi and 60 psi, or 20 psi and 55 psi, or 20 psi and 50 psi, or 20 psi and 45 psi, or 20 psi and 40 psi, or 20 psi and 35 psi, or 20 psi and 30 psi. The pressure of abrasive blasting may be at least about 5 psi, at least about 10 psi, at least about 15 psi, at least about 20 psi, at least about 25 psi, at least about 30 psi, at least about 35 psi, at least about 40 psi, at least about 45 psi, at least about 50 psi, at least about 55 psi, at least about 60 psi, at least about 65 psi, at least about 70 psi, at least about 75 psi, at least about 80 psi, at least about 85 psi, at least about 90 psi, at least about 95 psi, at least about 100 psi, or at least about 105 psi. In an alternative example, light hand abrasion may be executed using about 320 to 400 grit abrasive media to avoid distortions to light sections. The abrasive media can be at least about 310 grit, at least about 315 grit, at least about 320 grit, at least about 325 grit, at least about 330 grit, at least about 335 grit, at least about 340 grit, at least about 345 grit, at least about 350 grit, at least about 355 grit, at least about 360 grit, at least about 365 grit, at least about 370 grit, at least about 375 grit, at least about 380 grit, at least about 385 grit, at least about 390 grit, at least about 395 grit, at least about 400 grit, at least about 405 grit, or at least about 410 grit. The velocity of abrasive blasting may be at least about 100 feet per second (ft/sec), at least about 125 ft/sec, at least about 150 ft/sec, at least about 175 ft/sec, at least about 200 ft/sec, at least about 225 ft/sec, at least about 250 ft/sec, at least about 275 ft/sec, at least about 300 ft/sec, at least about 325 ft/sec, at least about 350 ft/sec, at least about 375 ft/sec, or at least about 400 ft/sec. The time of abrasive blasting may be at least about 5 seconds, 15 seconds, 20 seconds, 25 seconds, 30 seconds, 35 seconds, 40 seconds, 45 seconds, 50 seconds, 55 seconds, 60 seconds, 5 minutes, 10 minutes, 20 minutes, 30 minutes, 40 minutes, 50 minutes, or 60 minutes. The coarser grit can result in larger peaks and valleys. The various grits may also result in different roughnesses and aesthetics.

Stainless steel abrasive blasting media may be available in two particle geometries, shot and grit. The geometries may affect the shape and depth of the depressions cut into the substrate surface. For example, rounded shots may create rounded and smooth depressions. Contrarily, angular grits may generate surfaces with greater roughness and surface area. In some examples, the abrasive blasting material may comprise silica sand, garnet, plastic media, glass bead, silicon carbide, aluminum oxide, ceramic media, steel shot or grit, ground quartz, and stainless shot or grit.

The degree of roughness imparted on the substrate surface may be dependent on the shape, size, mass, or density of the blasting particle. For example, a particle that is twice as dense imparts roughly twice the energy at constant velocity. The impact velocity may proportionally affect the impact force. When a greater pressure is directed at the substrate surface, a deeper depression may be formed. In addition, the size of the grit, rather than the high air pressure, can generate a greater roughness of the surface.

Depending on the abrasive blasting media, the blasting angle on the substrate surface may be at least about 50°, 60°, 70°, 80°, or 90°. The blasting angle may be less than or equal to about 100°, 95°, 90°, 85°, 80°, 75°, 70°, or 65°. A more uniform abrasive media blasting may maximize the roughness of the substrate surface.

Substrates (e.g., stainless steel) may be roughened by forming depressions on the surface. The substrates may have hardnesses less than about 45 Rockwell scale C (HRC), about 40 HRC, about 35 HRC, about 30 HRC, about 25 HRC, about 20 HRC, about 15 HRC, or about 10 HRC. The surface may have a thickness of at least about 0.5 (millimeter) mm, 1 mm, 5 mm, 10 mm, 50 mm, 100 mm, and 500 mm. The stainless steel surface may result in a non-directional design with a range of coarseness. The texturized surface may have an average roughness (Rₐ) of at least about 30 μin, 40 μin, 50 μin, 60 μin, 70 μin, 80 μin, 90 μin, 100 μm, 200 μin, or 300 μin. The substrate may have a thickness of about 0.010 in to 0.1 in. For example, the thickness may be at least about 0.005, at least about 0.01, at least about 0.02, at least about 0.03, at least about 0.04, at least about 0.05, at least about 0.06, at least about 0.07, at least about 0.08, at least about 0.09, at least about 0.1, or at least about 0.15 in.

Abrasive grit blasting equipment for roughening the substrate surface may be selected from the group consisting of pressure machines, suction type nozzles, and centrifugal or airless blasting machines. The nozzle diameter and air pressure may affect the grit speed and the blasting effectiveness. The nozzle diameter may be 4.75 mm, 6.40 mm, 7.90 mm, 9.50 mm, 11 mm, or 12.70 mm.

Blasting abrasives types may be selected from the group consisting of angular chilled iron grit, alumina, crushed flint, crushed garnet, silicon carbide, and crushing slag. Chilled iron grit may have hardness measurements up to about 40 HRC, 41 HRC, 42 HRC, 43 HRC, 44 HRC, 45 HRC, 46 HRC, 47 HRC, 48 HRC, 49 HRC, 50 HRC, 51 HRC, 52 HRC, 53 HRC, 54 HRC, 55 HRC, 56 HRC, 57 HRC, 58 HRC, 59 HRC, 60 HRC, 61 HRC, 62 HRC, 63 HRC, 64 HRC, 65 HRC, 66 HRC, 67 HRC, 68 HRC, 69 HRC, 70 HRC, 71 HRC, 72 HRC, 73 HRC, 74 HRC, 75 HRC, 76 HRC, 77 HRC, 78 HRC, 79 HRC, or 80 HRC. The chilled iron grit may be used on surfaces as hard as 20 HRC, 21 HRC, 22 HRC, 23 HRC, 24 HRC, 25 HRC, 26 HRC, 27 HRC, 28 HRC, 29 HRC, 30 HRC, 31 HRC, 32 HRC, 33 HRC, 34 HRC, 35 HRC, 36 HRC, 37 HRC, 38 HRC, 39 HRC, 40 HRC, 41 HRC, 42 HRC, 43 HRC, 44 HRC, 45 HRC, 46 HRC, 47 HRC, 48 HRC, 49 HRC, 50 HRC, 51 HRC, 52 HRC, 53 HRC, 54 HRC, 55 HRC, 56 HRC, 57 HRC, 58 HRC, 59 HRC, or 60 HRC.

The substrate surface may also be roughed by machining and macro-roughening for thick coatings. Macro-roughing may be achieved by imparting grooves or threads into the substrate surface prior to spraying. The surface substrate may also be grit blasted. Bond coating may also be applied onto a substrate surface to generate a roughened surface.

The substrate surface may be roughened by abrasive belt grinding. On a mandrel, the stainless steel coil can be threaded onto a roll support. Abrasive belt grinding may be versatile because of the variety of belt types and contact wheels used. A 300 mm stainless steel substrate may be polished with an abrasive rotating belt concurrently with at least 1 polishing head, 2 polishing heads, 3 polishing heads, 4 polishing heads, 5 polishing heads, 6 polishing heads, 7 polishing heads, or 8 polishing heads.

Abrasive belt machining can remove metal at high rates. A stock removal rate may be at most about 400 cubic millimeter/second/millimeter (mm³/s/mm) of belt width. For example, the rate may be at most about 400 mm³/s/mm, 350 mm³/s/mm, 300 mm³/s/mm, 250 mm³/s/mm, 200 mm³/s/mm, 150 mm³/s/mm, 100 mm³/s/mm, or 50 mm³/s/mm of belt width. Ferrous and nonferrous metals may be roughened at belt speeds of 20 meter/second (m/s) to 55 m/s, or 20 m/s to 50 m/s, or 20 m/s to 45 m/s, or 20 m/s to 40 m/s, or 20 m/s to 35 m/s, or 20 m/s to 30 m/s, or 20 m/s to 25 m/s. For example, at most about 15 m/s, 20 m/s, 25 m/s, 30 m/s, 35 m/s, 40 m/s, 45 m/s, 50 m/s, or 55 m/s. Titanium can be roughened at belt speeds of 5 m/s to 20 m/s. For example, at most about 5 m/s, 10 m/s, 15 m/s, 25 m/s, or 30 m/s.

The abrasive belt may have extra support when pressure is applied during the roughening process. The extra support can be in the form of contact wheels, rolls, or platens. The contact wheel may comprise rubber, metal, cloth, or a specialized composition. The hardness and density of the wheel may impact the stock removal and the quality of roughness imparted on the substrate. For example, a harder wheel can impart more stock removal and a coarser finish. Texturized wheels may increase the unit pressure applied resulting in improved cutting action. Belt tensions may range from 0.5 Newton/millimeter (N/mm) to 15 N/mm of belt width, or 0.5 N/mm to 10 N/mm, or 0.5 N/mm to 9 N/mm, or 0.5 N/mm to 8 N/mm, or 0.5 N/mm to 7 N/mm, or 0.5 N/mm to 6 N/mm, or 0.5 N/mm to 5 N/mm, or 0.5 N/mm to 5 N/mm, or 0.5 N/mm to 4 N/mm, or 0.5 N/mm to 3 N/mm, or 0.5 N/mm to 2 N/mm, or 0.5 N/mm to 1 N/mm. For example, at most about 0.5 N/mm, 1 N/mm, 2 N/mm, 3 N/mm, 4 N/mm, 5 N/mm, 6 N/mm, 7 N/mm, 8 N/mm, 9 N/mm, 10 N/mm, or 15 N/mm of belt width. Low tension may be useful during low speed operations with soft-contact wheels to achieve maximum flexibility and resilience for contour texturizing. On the contrary, high tension may be useful with hard contact wheels and increased pressure on smaller contact areas. Tension may be increased by using springs, air cylinders, or suspend weights.

Abrasive belt machines may be selected from a group consisting of backside grinders, swing-frame grinders, free belt roll grinders, vertical grinders, and centerless grinders. Abrasive belt machines may be utilized for manual, semiautomatic, or fully automatic operations.

After the depression pattern is formed, to further improve the adhesion and preservation of the coating material upon addition to the substrate, the texturized surface may be cleaned by blowing the surface with dry air or nitrogen gas, washing with distilled water, or baking to remove particles that may not be included in the final part, such as undesired particles. The baking temperature can be at least about 100° C., 125° C., 150° C., 175° C., 200° C., 225° C., 250° C., 275° C., 300° C., 325° C., 350° C., 375° C., or 400° C.

A primer may be used to ensure that the roughened surface remains clean and rust-free. The primer may be selected from etch primers, epoxy primers, zinc epoxy primers, and zinc silicate primers. The primer may be applied to the roughened surface via various deposition approaches, such as application suing a solution having the primer.

The coating layer may be applied by a method that forms a suitable interaction with the substrate. For example, the color or clear coat may be either liquid or powder paints. Coating methods may include spray painting, high velocity oxygen fuel (HVOF) spraying, plasma spraying, thermal spraying, powder coat spraying, air knife coating, anilox coating, flexo coating, gap coating, gravure coating, hot melt coating, immersion dip coating, kiss coating, metering rod coating, roller coating, slurry coating, silk screen coater, slot die coating, inkjet printing, lithography, flexography, spin coating, dip coating, conversion coating, ion beam mixing, pickled and oiled treatments, plating, electrochemical deposition, metalorganic chemical vapour deposition (MOCVD), electrostatic spray assisted vapour deposition, sherardizing, epitaxy, cathodic arc deposition, electron beam physical vapor deposition (EBPVD), ion plating, ion beam assisted deposition (IBAD), magnetron sputtering, pulsed laser deposition, sputter deposition, vacuum deposition, vacuum evaporation, slot coating, or calandering. The coating method may be a continuous application such as spray painting or continuous coil coating. The continuous coil coating may have two or three roll set ups. For example, the coating may be formed using a slurry, such as, for example, using methods and systems disclosed in U.S. Patent Publication No. 2016/0230284, which is entirely incorporated herein by reference.

The coating method may be a continuous automated coil coating. The substrate may be delivered as a coil from the rolling mills. The coil can be positioned at the beginning of the coating line. The operations may include stitching the strip to the previous coil, cleaning the strip, power brushing, pre-treating with chemicals, drying the strip, applying primer on one or both sides, curing, cooling the strip, top coating on one or both sides, second curing, cooling down to room temperature, and rewinding of the coated coil. The speed of the operation may be at least about 500 feet per minute (ft/min), at least about 600 ft/min, at least about 700 ft/min, at least about 800 ft/min, at least about 900 ft/min, or at least about 1000 ft/min.

The coating material may be liquid thermosetting coating compositions and ambient temperature curing coating compositions. The coating material can comprise coloring pigments, resin, solvents, and/or the like. Resin components may comprise a base resin and/or a crosslinking agent. For example, the base resin may include acrylic resins, polyester resins, alkyd resins, and urethane resins. The base resins may further comprise crosslinkable functional group(s). For example, the crosslinkable functional groups may include hydroxy, epoxy, carboxy, and silanol. Crosslinking agents may include melamine resins, urea resins, polyisocyanate compounds, and blocked polyisocyanate compounds. The coating material may be epoxy resin and a crosslinking agent. The epoxy resin and the crosslinking agent may have a viscosity measured at 20° C. in the range of about 300 millipascal-second (mPa·s) to 4100 mPa·s, or 300 mPa·s to 4000 mPa·s, or 300 mPa·s to 3900 mPa·s, or 300 mPa·s to 3800 mPa·s, or 300 mPa·s to 3700 mPa·s, or 300 mPa·s to 3600 mPa·s, or 300 mPa·s to 3500 mPa·s, or 300 mPa·s to 3400 mPa·s, or 300 mPa·s to 3300 mPa·s, or 300 mPa·s to 3200 mPa·s, or 300 mPa·s to 3100 mPa·s, or 300 mPa·s to 3000 mPa·s, or 300 mPa·s to 2900 mPa·s, or 300 mPa·s to 2800 mPa·s, or 300 mPa·s to 2700 mPa·s, or 300 mPa·s to 2600 mPa·s, or 300 mPa·s to 2500 mPa·s, or 300 mPa·s to 2400 mPa·s, or 300 mPa·s to 2300 mPa·s, or 300 mPa·s to 2200 mPa·s, or 300 mPa·s to 2100 mPa·s, or 300 mPa·s to 2000 mPa·s, or 300 mPa·s to 1900 mPa·s, or 300 mPa·s to 1800 mPa·s, or 300 mPa·s to 1700 mPa·s, or 300 mPa·s to 1600 mPa·s, or 300 mPa·s to 1500 mPa·s, or 300 mPa·s to 1400 mPa·s, or 300 mPa·s to 1300 mPa·s, or 300 mPa·s to 1200 mPa·s, or 300 mPa·s to 1100 mPa·s, or 300 mPa·s to 1000 mPa·s, or 300 mPa·s to 900 mPa·s, or 300 mPa·s to 800 mPa·s, or 300 mPa·s to 700 mPa·s, or 300 mPa·s to 600 mPa·s, or 300 mPa·s to 500 mPa·s, or 300 mPa·s to 400 mPa·s. The viscosity may be at least about 200 mPa·s, 300 mPa·s, 400 mPa·s, 500 mPa·s, 600 mPa·s, 700 mPa·s, 800 mPa·s, 900 mPa·s, 1000 mPa·s, 1100 mPa·s, 1200 mPa·s, 1300 mPa·s, 1400 mPa·s, 1500 mPa·s, 1600 mPa·s, 1700 mPa·s, 1800 mPa·s, 1900 mPa·s, 2000 mPa·s, 2100 mPa·s, 2200 mPa·s, 2300 mPa·s, 2400 mPa·s, 2500 mPa·s, 2600 mPa·s, 2700 mPa·s, 2800 mPa·s, 2900 mPa·s, 3000 mPa·s, 3100 mPa·s, 3200 mPa·s, 3300 mPa·s, 3400 mPa·s, 3500 mPa·s, 3600 mPa·s, 3700 mPa·s, 3800 mPa·s, 3900 mPa·s, 4000 mPa·s, or 4100 mPa·s. The coating material may be solvent or water based. The solvents can be organic solvents. The solvents can dissolve the resin components and coloring pigments.

The coat may be selected from a group consisting of a whole color, combinations of colors, or color patterns. The color pattern may be predetermined by a user from design specifications. Examples of color coat pigments in terms of the Color Index (C.I.No.) may include White pigments: Pigment White 1, Pigment White 4, Pigment White 6, Black pigments: Pigment Black 1, Pigment Black 6, Pigment Black 7, Pigment Black 10, Pigment Black 11, Pigment Black 31, Pigment Black 32, Blue pigments: Pigment Blue 15, Pigment Blue 15:1, Pigment Blue 15:2, Pigment Blue 15:3, Pigment Blue 15:4, Pigment Blue 15:6, Pigment Blue 16, Pigment Blue 28, Pigment Blue 29, Pigment Blue 60, Pigment Blue 75, Pigment Blue 80, Pigment Violet 2.3, Green pigments: Pigment Green 7, Pigment Green 36, Pigment Green 37, Red pigments: Pigment Red 3, Pigment Red 48:2, Pigment Red 48:3, Pigment Red 48:4, Pigment Red 52:2, Pigment Red 88, Pigment Red 101, Pigment Red 104, Pigment Red 112, Pigment Red 122, Pigment Red 146, Pigment Red 168, Pigment Red 170, Pigment Red 177, Pigment Red 178, Pigment Red 179, Pigment Red 188, Pigment Red 202, Pigment Red 206, Pigment Red 207, Pigment Red 214, Pigment Red 224, Pigment Red 242, Pigment Red 251, Pigment Red 253, Pigment Red 254, Pigment Red 255, Pigment Red 256, Pigment Red 257, Pigment Red 264, Pigment Red 279, Pigment Violet 19, Pigment Violet 29, Orange pigments: Pigment Orange 5, Pigment Orange 36, Pigment Orange 43, Pigment Orange 62, Pigment Orange 67, Brown pigments: Pigment Brown 24, Pigment Brown 25, or Yellow pigments: Pigment Yellow 1, Pigment Yellow 3, Pigment Yellow 16, Pigment Yellow 34, Pigment Yellow 42, Pigment Yellow 53, Pigment Yellow 74, Pigment Yellow 75, Pigment Yellow 79, Pigment Yellow 81, Pigment Yellow 83, Pigment Yellow 109, Pigment Yellow 110, Pigment Yellow 129, Pigment Yellow 138, Pigment Yellow 139, Pigment Yellow 150, Pigment Yellow 151, Pigment Yellow 154, Pigment Yellow 155, Pigment Yellow 173, Pigment Yellow 184, Pigment Yellow 213.

The color coat pigments may also include a luster pigment. Examples of luster pigments may include but are not limited to flaky metallic pigments such as aluminum, copper, nickel alloys, stainless steel; flaky metallic pigments with metal oxide-covered surfaces; flaky metallic pigments with coloring pigments chemically adsorbed onto their surface; flaky aluminum pigments with an aluminum oxide layer formed by a surface oxidation-reduction reaction; colored aluminum pigments covered with coloring pigments or inorganic metal oxides; glass flake pigments; glass flake pigments having their surface covered with metals or metal oxides; glass flake pigments with coloring pigments chemically adsorbed onto the surface; interference mica pigments having their surface covered with titanium dioxide; reduced mica pigments obtained by reducing and coloring interference mica pigments; colored mica pigments with coloring pigments chemically adsorbed onto their surfaces; colored mica pigments with iron oxide-covered surfaces; graphite pigments with titanium dioxide-covered surfaces; silica flake pigments with titanium dioxide-covered surfaces; alumina flake pigments with titanium dioxide-coated surfaces; plate-like iron oxide pigments; holographic pigments; synthetic mica pigments; helical cholesteric liquid crystal polymer pigments.

The color coat may include additional ingredients such as, for example, plasticizers, surfactants, thixotropic agents, anti-gassing agents, organic co-solvents, flow controllers, anti-oxidants, UV light absorbers and similar additives may be included in the composition. These ingredients are typically present at up to about 5%, 10%, 15%, 20%, 25%, 30%, 35%, 40%, 45%, 50%, 55%, 60%, or 65% by weight based on the total weight of resin solids.

Coating the substrate may include rolling and surface coating. During rolling and surface coating, cast slabs of steel may be rolled into thin strips of steel at high temperature and then at room temperature. The cast slabs of steel may be at most about 150 mm, 160 mm, 170 mm, 180 mm, 190 mm, 200 mm, 210 mm, 220 mm, 230 mm, 240, 250 mm, or 260 mm in thickness. The cast slabs may weigh at most about 5 tonnes, 10 tonnes, 15 tonnes, 20 tonnes, or 25 tonnes.

During the hot rolling, cast slabs of steel may be heated in a gas reheating furnace until the temperature reaches at most about 1000° C., 1050° C., 1100° C., 1150° C., at most about 1200° C., 1250° C., 1300° C., or 1350° C. High pressure jets of water may then remove iron oxides from the steel surface. The slab may pass through large rollers. The roller direction may be reversed, and the slab can pass through the rollers again. This may occurs for about 5 to 10 passes. For example, at least about 5 roughening mill passes, 6 roughening mill passes, 7 roughening mill passes, 8 roughening mill passes, 9 roughening mill passes, or 10 roughening mill passes. After the roughening mill passes, the slab thickness may be lowered from about 250 mm to about 10 mm. For example, the slab thickness may be at least about 10 mm, 50 mm, 100 mm, 150 mm, 200 mm, 250 mm, or 300 mm. Following the final pass, the rolled slab may be coiled into a roll in a coil box.

Cold rolling may be required as an operation before painting. The operation before cold rolling may involve unwinding the coils of steel and cutting and recycling the tails of the coils. The welded strip of steel may be pickled in hydrochloric acid to remove the iron oxide contamination of the steel. The sheet may then be rinsed, dried, and oiled to block further corrosion. During cold rolling, the sheet thickness can be reduced and can be made smooth. The sheet may be rolled out and recoiled. Then the sheet can be passed through the mill in reverse direction between 5 passes and 10 passes to obtain the desired thickness, for example, at least about 5 passes, 6 passes, 7 passes, 8 passes, 9 passes, 10 passes, 11 passes, or 12 passes. The strip may then be cut and recoiled in preparation for the galvanising operation.

During the galvanising operation, the coils can be uncoiled and welded to generate a continuous steel strip. The strip may then be cleaned and degreased in a bath of hot alkali and water electrolysis. The oil may also be removed by roller brushes and hot water sprays. The alkali can then be removed by rinsing the steel. A hot pickle bath of hydrochloric acid may then remove contaminants of rust and can gently perform a surface etch. The cleaned strip can then enter a heat treatment furnace.

A zinc coating process may proceed by passing the steel from the annealing furnace to a molten bath of zinc. Aluminum and zinc may be added to the molten zinc. The galvanised steel may pass through a set of rollers in a leveler unit. The spray may then undergo a chromate spray.

During paint coating, feed coils may be uncoiled. A mechanical press stitcher can then join the feed coils. The coil may then undergo cleaning and pre-treatment to prepare the surface for coating. The cleaning and pre-treatment can include brush scrubbing, mild alkali degreasing, hot rinsing, phosphate coating, chromate coating, cold rinsing, and chromic acid sealing. During roll coating, the coil passes in an “S” fashion around multiple large rubber coated application rollers and primer and paint may be applied onto the sheet. After excess paint drips off, the remaining paint may be baked in a high temperature jet air at most about 200° C., 210° C., 220° C., 230° C., 240° C., 250° C., 260° C., or 270° C. The annealing may be baked at most about 10 seconds, 20 seconds, 30 seconds, 40 seconds, 50 seconds, or 60 seconds. The coating process for linear feet of coil may be at most 5 minutes at a speed between 100 feet/minute (ft/min) and 700 ft/min, or 100 ft/min and 650 ft/min, or 100 ft/min and 600 ft/min, or 100 ft/min and 550 ft/min, or 100 ft/min and 500 ft/min, or 100 ft/min and 450 ft/min, or 100 ft/min and 400 ft/min, or 100 ft/min and 350 ft/min, or 100 ft/min and 300 ft/min, or 100 ft/min and 250 ft/min, or 100 ft/min and 200 ft/min, or 100 ft/min and 150 ft/min, or 100 ft/min and 100 ft/min, or 100 ft/min and 50 ft/min. For example, the coating process may be at most 2 minutes, 3 minutes, 4 minutes, 5 minutes, 6 minutes, 7 minutes, or 8 minutes. The speed may be at most about 50 ft/min, 100 ft/min, 150 ft/min, 200 ft/min, 250 ft/min, 300 ft/min, 350 ft/min, 400, 450 ft/min, or 500 ft/min.

The substrate may be split coated, wherein a first layer of paint is applied and then partially annealed. Next, a second coat of paint may be applied and then fully annealed.

Liquid coating may comprise air or airless gun spray painting. The air spray gun may include various components. The components of the air spray gun may include an air compressor, a nozzle, and a paint basin. The paint may be pulled into the air stream and the compacted air may atomize the paint. Alternative, the air spray gun may comprise a pressure pot. The pressure pot may release pressure to atomize the paint injected into the air spray gun. The maximum air pressure may be at most about 100 psi, 95 psi, 90 psi, 85 psi, 80 psi, 75 psi, 70 psi, 65 psi, 60 psi, 55 psi, 50 psi, 45 psi, 40 psi, 35 psi, or 30 psi.

During airless spraying, the paint may be compressed under pressure and sprayed through an outlet onto the stainless steel substrate. The shape and dimensions of the outlet and the hydraulic pressure may impact the thickness of the deposited coat and the deposition rate. The maximum hydraulic pressure may be at most about 4000 psi, 3500 psi, 3000 psi, 2500 psi, 2000 psi, 1500 psi, 1000 psi, or 500 psi.

The air temperature, stainless steel substrate temperature, and the humidity may affect the success of the coat application. For example, temperature may affect the efficiency of solvent evaporation, spraying properties, and curing times. Humidity can be controlled so that the steel temperature may be at least about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., or 20° C. above dew point.

Powder coating may be thermoset coating or thermoplastic coating. The powder coating may be selected from polymers such as polyester, polyurethane, polyester-epoxy, straight epoxy, and acrylics. The powder coating may have a positive electrostatic charge. The spray gun can be an electrostatic gun. The electrostatic gun may be a corona gun or a tribo gun. A powder coating film may be applied onto the substrate surface using mechanical air spraying of a spray gun. The powder may also be applied to the substrate surface by a fluidized bed method.

The color coated substrate may be cured by subjecting the surface to thermal energy. During curing, the coated substrate surface is annealed to form a higher molecular weight crosslinked structure. Hardening a coat may employ two methods, air drying and baking. After the coat is applied onto the stainless steel substrate, the solvent may be removed by heating at a temperature of at most about 90° C., about 85° C., about 80° C., about 75° C., about 70° C., about 65° C., about 60° C., about 55° C., or about 50° C. As an alternative, the solvent may be removed by heating at a temperature of at least about 25° C., about 30° C., about 40° C., about 50° C., about 60° C., about 70° C., about 80° C., about 90° C., or about 100° C.

After the coat is applied to the stainless steel substrate, the coat may be annealed by convection, radiation, or conduction. The annealing atmosphere may comprise hydrogen, nitrogen, argon. The annealing atmosphere can be a vacuum. The stainless steel substrate may be annealed at a temperature of at least about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 260° C., about 270° C., about 280° C., about 290° C., or about 300° C. The stainless steel substrate may be baked or annealed for a time period that may be inversely proportional to the temperature at which the metal substrate is baked or annealed. The annealing process may occur during a time period of at least about 1 min. The annealing period of time may be at most about 5 seconds, 15 seconds, 20 seconds, 25 seconds, 30 seconds, 35 seconds, 40 seconds, 45 seconds, 50 seconds, 55 seconds, 60 seconds, 65 seconds, or 70 seconds. Alternatively, the annealing time may be at least about 1 second, 10 seconds, 30 seconds, 60 seconds, 2 minutes, 3 minutes, 4 minutes, 5 minutes, 10 minutes, 15 minutes, 30 minutes, 1 hour, 12 hours, or 1 day.

The curing process may comprise air drying. Once curing is complete, the coating material may be insoluble in water, solvent(s), or household cleaning agent(s) over the acceptable periods of time for the final application (e.g. number of rubs with methylethylketone for paint on appliances.

Rather than implementing a separate curing step, the substrate surface may be pre-heated and then the hot substrate may be sprayed with a powder film.

The total annealing time, including heating, can be at most about 60 seconds. For example, the total annealing time can be more than at most about 10 seconds, 20 seconds, 30 seconds, 40 seconds, 50 seconds, 60 seconds, 70 seconds, or 80 seconds. The maximum temperature during the annealing process may be reached in less than about 10 seconds, 20 seconds, 30 seconds, 40 seconds, 50 seconds, 60 seconds, 70 seconds, or 80 seconds.

After the substrate surface is cured, the powder coat film may be removed by mechanical or chemical techniques. A solvent may be applied to remove the powder coating. The solvent may be organic. The organic solvent may be benzyl alcohol or acetone. The powder coating may also be removed by 98% sulfuric acid commercial grade. Furthermore, the powder coating may also be removed by abrasive blasting technique, a burning off process, or with steel wool.

After the coat is applied onto the substrate surface, the coating may be modified and treated to enhance surface properties. Post coating operations may be surface treatments or internal treatments. Surface treatments may include dimensional treatment, non-dimensional treatment, or geometric treatment. Post coating processes may be selected from the group consisting of surface finishing, sealing, heat treatment, gauging and inspection, and densification. Surface finishing can be selected from a group consisting of polishing, grinding, vibratory finishing, lapping, brush finishing, diamond belt, and turning.

The coating weight may be at least about 2 milligram per square inch (mg/in²), 3 mg/in², 4 mg/in², 5 mg/in², 6 mg/in², 7 mg/in², 8 mg/in², 9 mg/in², 10 mg/in², 11 mg/in², 12 mg/in², 13 mg/in², 14 mg/in², 15 mg/in², 16 mg/in², 17 mg/in², 18 mg/in², or 20 mg/in². The coefficient of variance (COV) may be at most about 1%, 2%, 3%, 4%, 5%, 6%, 7%, 8%, 9%, 10%, or 20%.

Dimensional surface treatments may change the coated surface to satisfy specific size tolerances, geometric profiles, and surface finish. Grinding may result in various surface finishings including roundness, flatness, concentricity, surface finish, perpendicularity, geometric profile, parallelism, and dimensional tolerances. Grinding machinery may be selected based on the desired final surface finish. The grinding machinery can be selected from the group consisting of surface grinder for flat surfaces, cylindrical or outer diameter grinder for outer diameters of cylinders between centers, centerless grinder for grinding outer diameters of cylinders without the use of centers, internal or inner diameter grinder for grinding the inner diameters of the cylinders, or jig grinder for intricate shapes and holes with high degree of accuracy.

Honing using abrasive stones on the coated substrate surface may generate a precise surface finish of the inner and outer diameters. Another dimensional finishing process is diamond lapping. Diamond lapping may generate flatness on the stainless steel substrate less than about 0.035 μin Rₐ, 0.05 μin Rₐ, 0.1 μin Rₐ, 0.2 μin Rₐ, 0.3 μin Rₐ, 0.4 μin Rₐ, 0.5 μin Rₐ, 0.6 μin Rₐ, 0.7 μin Rₐ, 0.8 μin Rₐ, 0.9 μin Rₐ, about 1 μin Rₐ, 2 μin Rₐ, 3 μin Rₐ, 4 μin Rₐ, 5 μin Rₐ, 6 μin Rₐ, 7 μin Rₐ, 8 μin Rₐ, about 9 μin Rₐ, about 10 μin Rₐ, about 15 μin Rₐ, or about 20 μin Rₐ.

Non-dimensional finishing applied to a coated surface may generate a desired surface finish or texture. Non-dimensional finishing may include vibratory finishing, shot peening with steel, ceramic, or glass beads, or brush finishing with rotary wire brush or finishing with abrasive pads, such as a drag pad. The drag pad may be used to apply a buff pass to remove excess color from high surfaces.

The type of coating and the targeted application of the coated substrate may dictate the parameters considered during the post coating treatment. For example, the parameters may include the arithmetic mean of the absolute values (Rₐ), amplitude, slope, spacing, counting, profile, bearing ratio, area roughness, and fractal theory.

In some cases, post coating treatment of the steel substrate may remove the coating material from a location above the depression and above a plane of the surface. The treatment can expose the metal above the plane of at least one depression. The removal operation may be polishing or buffing to lower the roughness to an Rₐ at most about 5 μin, 10 μin, 15 μin, 20 μin, 25 μin, 30 μin, 40 μin, 50 μin, or 100 On. The polishing or buffing may also raise the gloss level of the substrate.

The post coating polishing may be performed in the same manner as the pre-treatment surface roughening. The polishing may be completed by belt grinding. The polishing may be done with fine media. The fine media may be a SiC belt. The fine media can be at least about 100 grit, 120 grit, 140 grit, 160 grit, 180 grit, 200 grit, 220 grit, 240 grit 260 grit, 280 grit, 300 grit, 350 grit, 400 grit, 450 grit, 500 grit, or 550 grit. During belt grinding, the coil may be polished at a speed of at least about 50 ft/min, 100 ft/min, 150 ft/min, 200 ft/min, 250 ft/min, 300 ft/min, or 350 ft/min. The coil may be polished a time of at least about 1 second, 5 seconds, 10 seconds, 15 seconds, 20 seconds, 30 seconds, 40 seconds, 50 seconds, 60 seconds, 70 seconds, or 80 seconds to remove paint from the high spots of the substrate.

Internal treatments may change the deposited coating layer on the substrate. For example, internal treatments may include sealing, heat treating, and peening. Sealing a coating layer may prevent corrosive damage to the substrate and ensure integrity to the substrate. Other functions of sealants include, for example, corrosion protection, pressure seal, friction control, release/nonstick surface, generate hydrophilic or hydrophobic surface. The sealant may include, for example, epoxy phenolics, epoxy resins, and silicate based chemicals. The sealant maybe applied, for example, on the coated surface by brushing, spraying, or dipping and then air cured or thermally cured. After the sealant application, the substrate may be polished.

Inspection of the coated substrate may follow within at least about 1 second, about 2 seconds, about 3 seconds, about 4 seconds, about 5 seconds, about 6 seconds, about 7 seconds, about 8 seconds, about 9 seconds, or about 10 seconds of the spray process. The inspection may be non-destructive testing or destructive testing.

Non-destructive testing may be a visual inspection. The visual inspection may be a search for cracking, pitting, spallation, blistering, and abnormal color. The visual inspection may be done by eye or by magnification less than about 2×, about 3×, about 4×, about 5×, about 6×, about 7×, about 8×, about 9×, about 10×, about 11×, about 12×, about 13×, about 14×, about 15×, about 16×, about 17×, about 18×, about 19×, or about 20×. The substrate finish may be measured using a surface profilometer. Dimensional measurements can be measured, for example, by calipers or micrometers. The substrate surface depression defects may be recognized by a fluorescent penetrant.

Destructive testing may be done on a witness sample. The witness sample is a mimic of the coated substrate material. Correlations between the witness sample and the actual sample may be deduced from the destructive testing. The correlations may include characteristics such as metallography, bond strength, density, chemical composition, and thermal shock testing.

On the finished substrate, about 5% to 50%, or 5% to 40%, or 5% to 30%, or 5% to 20%, or 5% to 15%, or 5% to 10% of the surface may be non-painted stainless steel. For example, at least about 1%, 5%, 10%, 15%, 20%, 25%, 30%, 35%, or 40% of the surface may be non-painted stainless steel. The post coating polishing on the substrate may yield a predetermined appearance. The predetermined appearance may be a metallic appearance. The substrate may comprise one or more defects and wherein the polishing seals the one or more defects.

The coated substrate, after annealing, may yield a layer that may have a certain appearance. Such appearance may be tailored for various applications or uses. The layer may have an appearance similar to stainless steel. The layer may have an appearance that is shiny, dull, or a combination thereof. The surface of the layer may have a certain finish, for example, a coarse finish, an abrasive finish, a brushed finish, a sheen finish, a satin finish, a matte finish, a metallic finish, a reflective finish, a mirror finish, a wood finish, a dull finish, or combinations thereof.

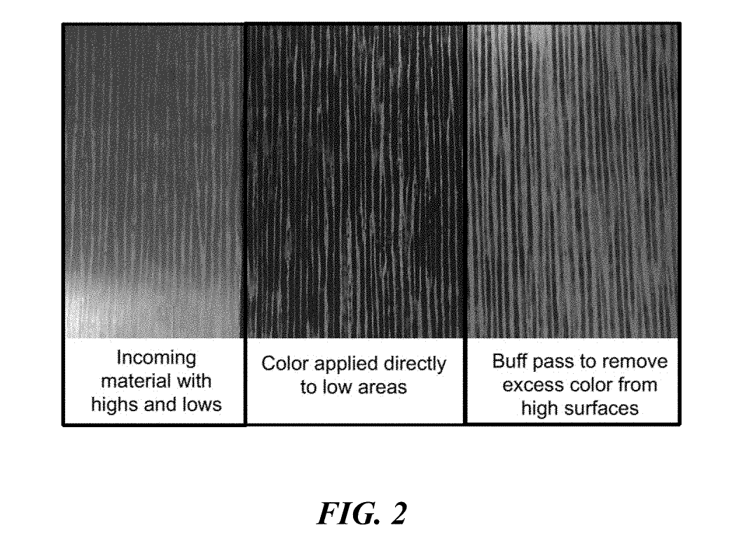

The appearance of a layer may include, but is not limited to, a grainy texture, streaks, lines, various geometric shapes or combination of shapes, or a combination thereof. The surface of a layer may have streaks. The streaks may be alternating between a dull finish and a shiny finish. The streaks may have short range or long range order. As an alternative, the streaks may not be ordered. In some examples, the streaks have dimensions of at least about 0.01 centimeter (cm), 0.1 cm, 0.5 cm, 1 cm, 2 cm, 3 cm, 5 cm, or more. FIG. 2 illustrates three panels: a scratched substrate with highs and lows, a coated substrate, and a polished substrate with color removed from the high surfaces.

The coating on the surface may have a horizontal or a vertical brush pattern. The change in horizontal to vertical brush pattern may yield a reflectivity change from light to dark. The reflectivity change can occur in florescent or natural light.

The brush pattern can be observed in florescent or natural light. The brush pattern can be observed at a range of 5 feet (ft) to 65 ft, or 5 ft to 60 ft, or 5 ft to 55 ft, or 5 ft to 50 ft, or 5 ft to 45 ft, or 5 ft to 40 ft, or 5 ft to 35 ft, or 5 ft to 30 ft, or 5 ft to 20 ft, or 5 ft to 15 ft from a panel at which the brush pattern can be resolved. For example, the brush pattern may be observed at a range of at least about 1 foot, 5 ft, 10 ft, 15 ft, 20 ft, 25 ft, 30 ft, 35 ft, 40 ft, or 45 ft. Rolled pattern may be one of two types: 1-sided pattern or 2-sided pattern. For the 1-sided pattern, the reverse side may be plain and may be classified as 2M. For the 2-sided pattern, the pattern may be imprinted through to the reverse side and classified at 2 W.

In another aspect, the present disclosure provides a method for forming a stainless steel part, comprising: providing a substrate comprising stainless steel. The substrate may be adjacent to a support. The substrate may include a surface. The surface may be an exposed surface. The substrate can comprise at least one depression in accordance with a depression pattern, which at least one depression can project into at least a portion of the substrate from a surface of the substrate. The method may also comprise providing a coating material on at least one portion of the surface having at least one depression. The coating may provide an average roughness (Rₐ) of about 7 micro inches (μin) to 200 μin, or 7 μin to 190 μin, or 7 μin to 180 μin, or 7 μin to 170 μin, or 7 μin to 160 μin, or 7 μin to 150 μin, or 7 μin to 140 μin, or 7 μin to 130 μin, or 7 μin to 120 μin, or 7 μin to 110 μin, or 7 μin to 100 μin, or 7 μin to 90 μin, or 7 μin to 80 μin, or 7 μin to 70 μin, or 7 μin to 60 μin, or 7 μin to 50 μin, or 7 μin to 40 μin, or 7 μin to 30 μin, or 7 μin to 20 μin, or 20 μin to 200 μin, or 20 μin to 180 μin, or 30 μin to 110 μin, or 40 μin to 110 μin, or 60 μin to 110 μin, or 80 μin to 110 μin as measured by profilometry and at least any two of (i) a lightness from about 5 to 120, or 5 to 110, or 5 to 100, or 5 to 90, or 5 to 80, or 5 to 70, or 5 to 60, or 5 to 50, or 5 to 40, or 5 to 30, or 5 to 20, or 20 to 100, or 30 to 80, or 40 to 70 at an incident angle to brush pattern of 90° as measured by spectrophotometry, (ii) a sparkle intensity from about 1 to 20, or 1 to 19, or 1 to 18, or 1 to 17, or 1 to 16, or 1 to 15, or 1 to 14, or 1 to 13, or 1 to 12, or 1 to 11, or 1 to 10, or 1 to 9, or 1 to 8, or 1 to 7, or 1 to 6, or 1 to 5, or 5 to 15, or 10 to 15, or 10 to 20 at an incident angle to brush pattern of 90° as measured by spectrophotometry, (iii) a sparkle area from about 5 to 100, or 5 to 90, or 5 to 80, or 5 to 70, 5 to 60, or 5 to 50, or 5 to 40, or 5 to 30, or 5 to 20, or 10 to 90, or 15 to 70, or 20 to 60, or 30 to 50 at an incident angle to brush pattern of 90° as measured by spectrophotometry, and (iv) a graininess level from about 2 to 20, or 2 to 19, or 2 to 18, or 2 to 17, or 2 to 16, or 2 to 15, or 2 to 14, or 2 to 13, or 2 to 12, or 2 to 11, or 2 to 10, or 2 to 9, or 2 to 8, or 2 to 7, or 2 to 6, or 2 to 5, or 2 to 4, or 2 to 3 as measured by spectrophotometry.

In another aspect, the present disclosure provides a stainless steel part, comprising a substrate comprising stainless steel. The substrate may comprise at least one depression in accordance with a depression pattern. At least one depression projects into at least a portion of the substrate from a surface of the substrate. The stainless steel part may further comprise a coating material on at least one portion of the surface having at least one depression. The coating may provide an average roughness (Rₐ) of about 7 micrometers inches (μin) to 200 μin, or 7 μin to 190 μin, or 7 μin to 180 μin, or 7 μin to 170 μin, or 7 μin to 160 μin, or 7 μin to 150 μin, or 7 μin to 140 μin, or 7 μin to 130 μin, or 7 μin to 120 μin, or 7 μin to 110 μin, or 7 μin to 100 μin, or 7 μin to 90 μin, or 7 μin to 80 μin, or 7 μin to 70 μin, or 7 μin to 60 μin, or 7 μin to 50 μin, or 7 μin to 40 μin, or 7 μin to 30 μin, or 7 μin to 20 μin, or 20 μin to 200 μin, or 20 μin to 180 μin, or 30 μin to 110 μin, or 40 μin to 110 μin, or 60 μin to 110 μin, or 80 μin to 110 μin as measured by profilometry and at least any two of (i) a lightness from about 5 to 120, or 5 to 110, or 5 to 100, or 5 to 90, or 5 to 80, or 5 to 70, or 5 to 60, or 5 to 50, or 5 to 40, or 5 to 30, or 5 to 20, or 20 to 100, or 30 to 80, or 40 to 70 at an incident angle to brush pattern of 90° as measured by spectrophotometry, (ii) a sparkle intensity from about 1 to 20, or 1 to 19, or 1 to 18, or 1 to 17, or 1 to 16, or 1 to 15, or 1 to 14, or 1 to 13, or 1 to 12, or 1 to 11, or 1 to 10, or 1 to 9, or 1 to 8, or 1 to 7, or 1 to 6, or 1 to 5, or 5 to 15, or 10 to 15, or 10 to 20 at an incident angle to brush pattern of 90° as measured by spectrophotometry, (iii) a sparkle area from about 5 to 100, or 5 to 90, or 5 to 80, or 5 to 70, 5 to 60, or 5 to 50, or 5 to 40, or 5 to 30, or 5 to 20, or 10 to 90, or 15 to 70, or 20 to 60, or 30 to 50 at an incident angle to brush pattern of 90° as measured by spectrophotometry, and (iv) a graininess level from about 2 to 20, or 2 to 19, or 2 to 18, or 2 to 17, or 2 to 16, or 2 to 15, or 2 to 14, or 2 to 13, or 2 to 12, or 2 to 11, or 2 to 10, or 2 to 9, or 2 to 8, or 2 to 7, or 2 to 6, or 2 to 5, or 2 to 4, or 2 to 3 as measured by spectrophotometry.

The roughness may be at least about 1 μin, 2 μin, 3 μin, 4 μin, 5 μin, 6 μin, 7 μin, 8 μin, 9 μin, 10 μin, 20 μin, 30 μin, 40 μin, 50 μin, 60 μin, 70 μin, 80 μin, 90 μin, 100 μin, 110 μin, 120 μin, 130 μin, 140 μin, 150 μin, 160 μin, 170 μin, or 180 μin. The roughness may be at most about 200 μin, 190 μin, 180 μin, 170 μin, 160 μin, 150 μin, 140 μin, 130 μin, 120 μin, 110 μin, 100 μin, 90 μin, 80 μin, 70 μin, 60 μin, 50 μin, 40 μin, 30 μin, or 20 μin. The lightness may be at least about 1, 2, 3, 4, 5, 6, 7, 8, 9, 10, 15, 20, 30, 40, 50, 60, 70, 80, 90, or 100. The lightness may be at most about 110, 100, 90, 80, 70, 60, 50, 40, 30, 20, 10, or 5. The sparkle intensity may be at least about 1, 2, 3, 4, 5, 6, 7, 8, 9, 10, 11, 12, 13, 14, 15, 16, 17, or 18. The sparkle intensity may be at most about 20, 19, 18, 17, 16, 15, 14, 13, 12, 11, 10, 9, 8, 7, 6, 5, 4, 3, or 2. The sparkle area may be at least about 1, 2, 3, 4, 5, 6, 7, 8, 9, 10, 15, 20, 30, 40, 50, 60, 70, 80. The sparkle area may be at most about 100, 90, 80, 70, 60, 50, 40, 30, 20, or 10. The graininess may be at least about 1, 2, 3, 4, 5, 6, 7, 8, 9, 10, 11, 12, 13, 14, 15, 16, 17, or 18. The graininess may be at most about 20, 19, 18, 17, 16, 15, 14, 13, 12, 11, 10, 9, 8, 7, 6, 5, or 4.

The coating may comprise at least any three of the characteristics (i)-(iv). The coating may further comprise all of the characteristics (i)-(iv). The substrate can comprise an outer stainless steel layer diffusion bonded to an underlying layer. The underlying layer can comprise carbon, silicon, manganese, phosphorus, sulfur, nickel, chromium, molybdenum, copper, and nitrogen or combinations thereof. The underlying layer can comprise carbon.

In accordance with a depression pattern, at least about 1, 2, 3, 4, 5, 6, 7, 8, 9, 10, 15, 20, 25, 50, or 100 depressions may be generated in the substrate. The coating material may be deposited on a portion of the surface having at least one depression. Furthermore, at least a portion of the surface with the coating material may be cured. The coating on the surface may have an average roughness of at least about 1 μin, 2 μin, 3 μin, 4 μin, 5 μin, 6 μin, 7 μin, 8 μin, 9 μin, 10 μin, 20 μin, 30 μin, 40 μin, 50 μin, 60 μin, 70 μin, 80 μin, 90 μin, 100 μin, 110 μin, 120 μin, 130 μin, 140 μin, 150 μin, 160 μin, 170 μin, 180 μin, 190 μin, 200 μin, 250 μin, or 300 μin. At least one depression can project through the stainless steel substrate. At least one depression can yield a texturized stainless steel surface.

Viewing the coated substrate can depend on the reflective properties of light. The coating may be a black finish. Reflection may be classified as either specular reflection or diffuse reflection. Specular reflection can be the reflection from a smooth surface. On the other hand, diffuse reflection may be the reflection from rough surfaces. The smoothness and roughness of a surface may immensely impact the succeeding light beam reflection. Upon a smooth surface, the light beam may reflect and remain concentrated in a bundle when departing the surface. However, for a rough surface, the light rays can reflect and then diffuse in several different directions. The rays may be incident upon the coated surface in a concentrated bundle and then diffused upon reflection. The specular reflection angle may be at least about 1°, 2°, 3°, 4°, 5°, 6°, 7°, 8°, 9°, 10°, 15°, 20°, 25°, 30°, 35°, 40°, 45°, 50°, 55°, 60°, 65°, 70°, 75°, 80°, 85°, or 90°. The diffuse reflection angle may be at least about 1°, 2°, 3°, 4°, 5°, 6°, 7°, 8°, 9°, 10°, 15°, 20°, 25°, 30°, 35°, 40°, 45°, 50°, 55°, 60°, 65°, 70°, 75°, 80°, 85°, or 90°.

The incident angle may be between the incident ray on the coated surface and the perpendicular line to the coated surface with a brush pattern. The incident angle may be measured when a light meets the coated brush pattern surface. For example, the incident angle to brush pattern may be parallel at 0° and perpendicular at 90°. The incident angle may be at least about 0°, 5°, 10°, 15°, 20°, 25°, 30°, 35°, 40°, 45°, 50°, 55°, 60°, 65°, 70°, 75°, 80°, 85°, or 90°.

Several parameters may be measured from the coated surface. The parameters may be selected from the group consisting of angle dependent light intensity, sparkle intensity, sparkle area, graininess, detectable sparkle distance, and surface roughness. Total sparkle grade may be calculated as a function of sparkle intensity and sparkle area. The average surface roughness may be measured by profilometry. The profilometer may be a Sterrett SR400 or a MahrFederal PocketSurf 4. The profilometer can be optical or stylus. During profilometry, the coated surface roughness may be measured as the surface moves relative to the contact profilometer's stylus. Stylus profilometers may utilize a probe to detect the coated surface. The probe can physically move along the coated surface to determine the surface height. Optical profilometry can use light rather than a physical probe to expose the coated surface in three dimensions. Examples of optical methods may include digital holographic microscopy, phase shifting interferometry, differential interference contrast microscopy, focus detection methods, and pattern projection methods. Focus detection methods can comprise intensity detection, focus variation, differential detection, critical angle method, astigmatic method, foucault method, and confocal microscopy. Pattern projection methods can comprise fringe projection, fourier profilometry, moire, and pattern reflection methods. Contact and pseudo contact methods can comprise stylus profilometer, atomic force microscopy, and scanning tunneling microscopy.

The angle dependent light intensity, sparkle intensity, sparkle area, and graininess may be measured with spectrophotometry. The spectrophotometer may be a BYK-mac spectrophotometer. The BYK-mac spectrophotometer can provide multi-angle color measurements that determine the light-dark and color flop finishes of the coated surface. In addition, the BYK-mac spectrophotometer can provide sparkling and graininess control with a high resolution charged coupled device (CCD) camera that excites effect changes under diffuse and direct lighting conditions.

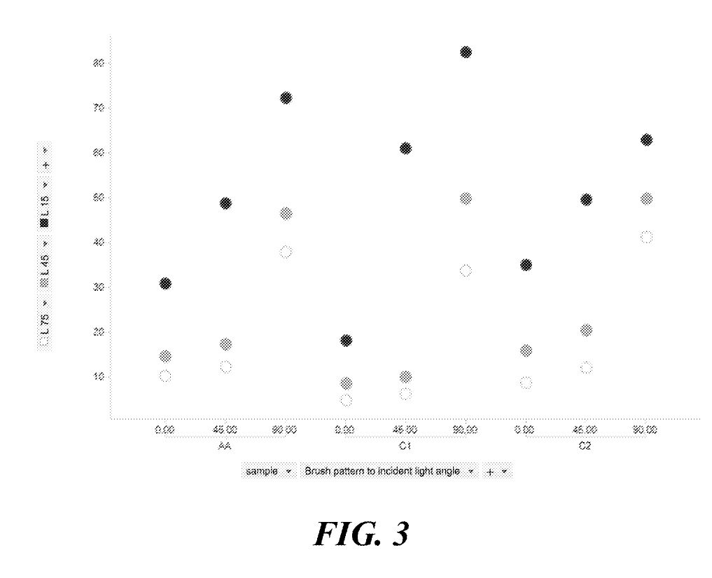

The light intensity may be measured as a function of incident angle to brush pattern and reflection angle. FIG. 3 illustrates the spectrophotometer measurements of lightness (y-axis) at an incident angle to brush pattern of 0°, 45°, and 90° (x-axis) for samples C1, C2, and AA. Samples C1 and C2 are reference samples formed using other commercially available approaches. Sample AA is formed using methods of the present disclosure. Sample AA has a black finish. The reflection angle may be 15° for specular reflection and 75° for diffuse reflection. The light intensity may be at least about 1, 5, 10, 15, 20, 25, 30, 35, 40, 45, 50, 55, 60, 65, 70, 75, 80, 85, 90, or 100. The light intensity at an incident angle to brush pattern of 0° at specular reflection angle of 15° may be at least about 20, 25, 30, 35, 40, 45, 50, 55, 60, 65, or 70. The light intensity at an incident angle to brush pattern of 45° at specular reflection angle of 15° may be at least about 30, 35, 40, 45, 50, 55, 60, 65, or 70. The light intensity at an incident angle to brush pattern of 90° at specular reflection angle of 15° may be at least about 40, 45, 50, 55, 60, 65, 70, 75, 80, 85, 90, or 100.

The light intensity at an incident angle to brush pattern of 0° at diffuse reflection angle of 45° may be at least about 1, 2, 3, 4, 5, 6, 7, 8, 9, 10, 11, 12, 13, 14, 15, 16, 17, 18, 19, or 20. The light intensity at an incident angle to brush pattern of 45° at diffuse reflection angle of 45° may be at least about 5, 6, 7, 8, 9, 10, 11, 12, 13, 14, 15, 16, 17, 18, 19, 20, 21, 22, 23, 24, 25, 26, 27, 28, 29, or 30. The light intensity at an incident angle to brush pattern of 90° at diffuse reflection angle of 45° may be at least about 30, 35, 40, 45, 50, 55, 60, 65, 70, 75, or 80.

The light intensity at an incident angle to brush pattern of 0° at diffuse reflection angle of 75° may be at least about 5, 10, 15, 20, 25, or 30. The light intensity at an incident angle to brush pattern of 45° at diffuse reflection angle of 75° may be at least about 5, 10, 15, 20, 25, 30, 35, or 40. The light intensity at an incident angle to brush pattern of 90° at diffuse reflection angle of 75° may be at least about 20, 25, 30, 35, 40, 45, 50, 55, 60, 65, or 70.

The sparkle measurements may be gathered under direct illumination. The angle of illumination can impact and vary the sparkle impression. The BYK-mac spectrophotometer may use a light emitting diode to illuminate the sample at 15°, 45°, and 75° and then takes a photo with the CCD camera. The photos can be analyzed with the histogram of lightness levels. The histogram can be used as the basis for calculating the sparkle area, sparkle intensity, and sparkle grade.

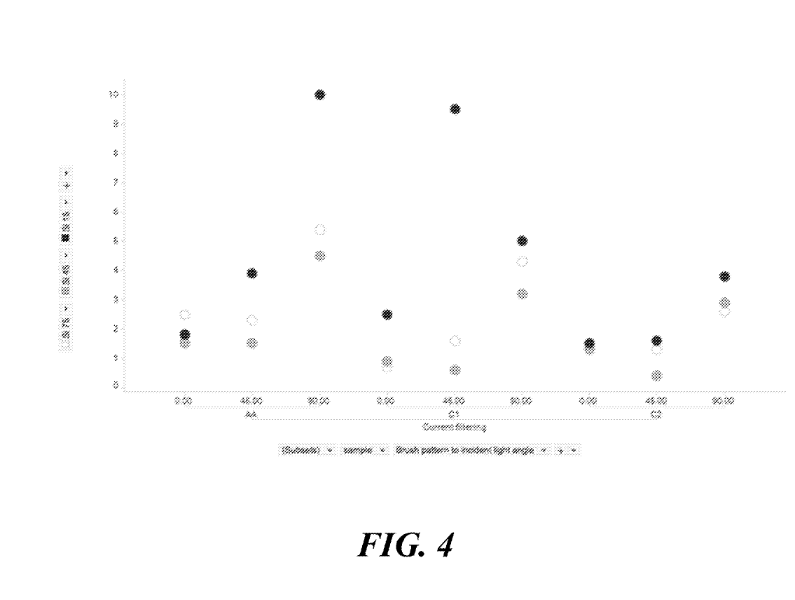

The sparkle intensity may be measured as a function of incident angle to brush pattern and reflection angle. FIG. 4 illustrates the spectrophotometer measurements of sparkle intensity (y-axis) at an incident angle to brush pattern of 0°, 45°, and 90° (x-axis) for samples C1, C2, and AA. Samples C1 and C2 are reference samples formed using other commercially available approaches. Sample AA is formed using methods of the present disclosure. Sample AA has a black finish. The reflection angles may be 15°, 45°, and 75°. Angle 15° may be specular reflection and angle 75° may be diffuse reflection. The sparkle intensity may be at least about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, or 13. The sparkle intensities are higher at an incident angle to brush pattern of 90° at reflection angles of 15°, 45°, and 75° for AA than for C1 and C2. The sparkle intensity at an incident angle to brush pattern of 0° at specular reflection angle of 15° may be at least about 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. The sparkle intensity at an incident angle to brush pattern of 45° at specular reflection angle of 15° may be at least about 2.0, 2.2, 2.4, 2.6, 2.8, 3.0, 3.2, 3.4, 3.6, 3.8, 4.0, 4.2, 4.4, 4.6, 4.8, or 5.0. The sparkle intensity at an incident angle to brush pattern of 90° at specular reflection angle of 15° may be at least about 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, or 12.

The sparkle intensity at an incident angle to brush pattern of 0° at diffuse reflection angle of 45° may be at least about 1, 1.1 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3. The sparkle intensity at an incident angle to brush pattern of 45° at diffuse reflection angle of 45° may be at least about 1, 1.1 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3. The sparkle intensity at an incident angle to brush pattern of 90° at diffuse reflection angle of 45° may be at least about 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6.

The sparkle intensity at an incident angle to brush pattern of 0° at diffuse reflection angle of 75° may be at least about 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0. The sparkle intensity at an incident angle to brush pattern of 45° at diffuse reflection angle of 75° may be at least about 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0. The sparkle intensity at an incident angle to brush pattern of 90° at diffuse reflection angle of 75° may be at least about 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, or 7.0.

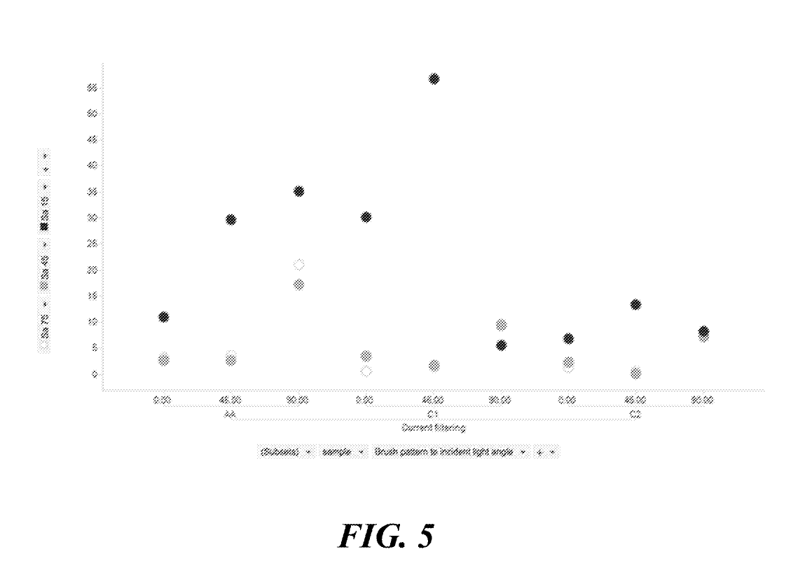

The sparkle area may be measured as a function of incident angle to brush pattern and reflection angle. FIG. 5 illustrates the spectrophotometer measurements of sparkle area (y-axis) at an incident angle to brush pattern of 0°, 45°, and 90° (x-axis) for samples C1, C2, and AA. Samples C1 and C2 are reference samples formed using other commercially available approaches. Sample AA is formed using methods of the present disclosure. Sample AA has a black finish. The reflection angle may be 15°, 45°, or 75°. Angle 15° may represent specular reflection and 75° may represent diffuse reflection. The sparkle area may be at least about 5, 10, 15, 20, 25, 30, 35, 40, 45, 50, 55, 60, 65, 70, 75, or 80. The sparkle areas are higher at an incident angle to brush pattern of 90° at reflection angles of 15°, 45°, and 75° for AA than for C1 and C2. The sparkle area at an incident angle to brush pattern of 0° at specular reflection angle of 15° may be at least about 1, 2, 3, 4, 5, 6, 7, 8, 9, 10, 11, 12, 13, 14, 15, 16, 17, 18, 19, or 20. The sparkle area at an incident angle to brush pattern of 45° at specular reflection angle of 15° may be at least about 25, 26, 27, 28, 29, 30, 31, 32, 33, 34, 35, 36, 37, 38, 39, or 40. The sparkle area at an incident angle to brush pattern of 90° at specular reflection angle of 15° may be at least about 25, 26, 27, 28, 29, 30, 31, 32, 33, 34, 35, 36, 37, 38, 39, 40, 41, 42, 43, 44, or 45.

The sparkle area at an incident angle to brush pattern of 0° at diffuse reflection angle of 45° may be at least about 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, or 7.0. The sparkle area at an incident angle to brush pattern of 45° at diffuse reflection angle of 45° may be at least about 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, or 7.0. The sparkle area at an incident angle to brush pattern of 90° at diffuse reflection angle of 45° may be at least about 6, 8, 10, 12, 14, 16, 18, 20, 22, 24, 26, 28, 30, 32, 34, or 36.

The sparkle area at an incident angle of 0° at diffuse reflection angle of 75° may be at least about 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, or 7.0. The sparkle area at an incident angle to brush pattern of 45° at diffuse reflection angle of 75° may be at least about 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, or 7.0. The sparkle area at an incident angle of 90° at diffuse reflection angle of 75° may be at least about 10, 12, 14, 16, 18, 20, 22, 24, 26, 28, 30, 32, 34, 36, 38, or 40.

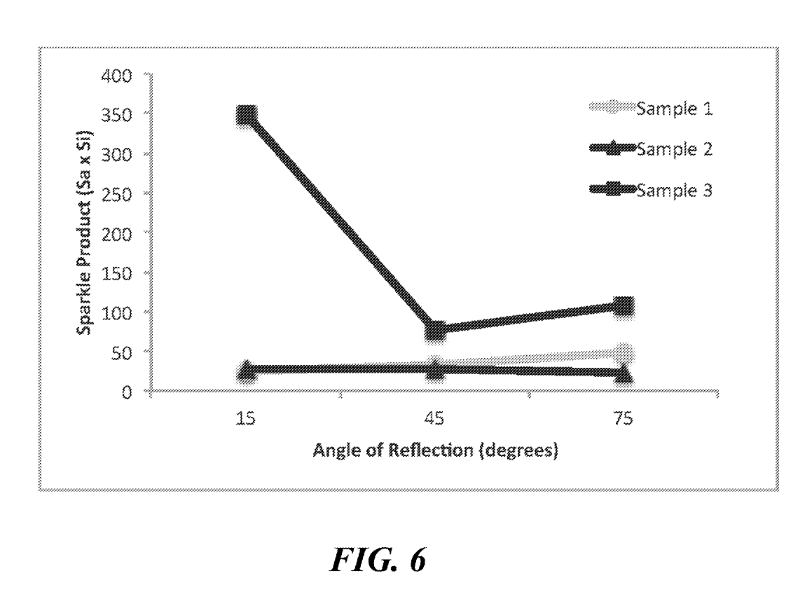

The sparkle grade may be calculated as the product of sparkle intensity and sparkle area. FIG. 6 illustrates the sparkle grade for three samples with sample 3 showing the higher sparkle grade values (y-axis) at angles of reflection of 15°, 45°, and 75° (x-axis) than samples 1 and 2. Samples 1 and 2 are reference samples formed using other commercially available approaches. Sample 3 is formed using methods of the present disclosure. Sample 3 has a black finish. The sparkle grade may be at least about 25, 50, 75, 100, 125, 150, 175, 200, 225, 250, 275, 300, 325, 350, 375, 400, 425, 450, 475, or 500. The sparkle grade at a reflection angle of 15° may be at least about 200, 225, 250, 275, 300, 325, 350, 375, or 400. The sparkle grade at a reflection angle of 45° may be at least about 25, 50, 75, 100, 125, or 150. The sparkle grade at a reflection angle of 75° may be at least about 50, 75, 100, 125, 150, 175, or 200.

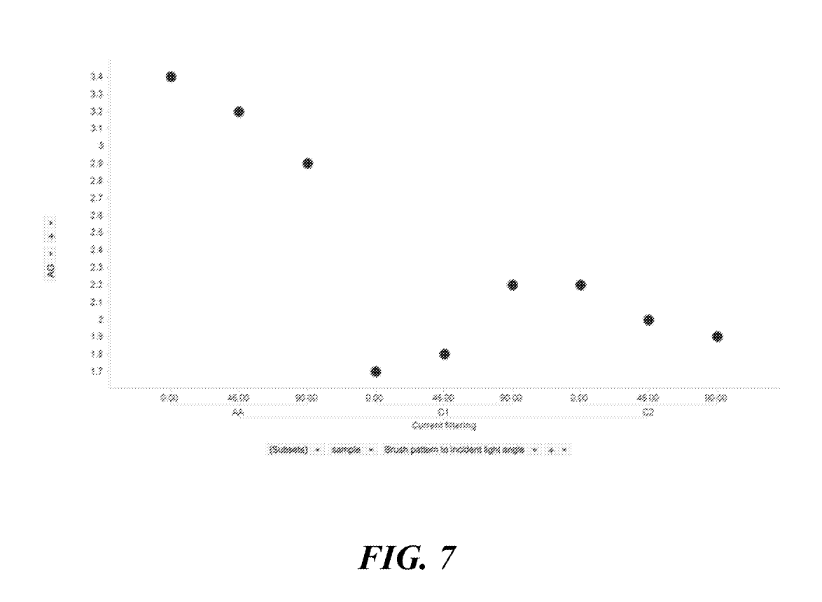

The graininess may be measured as a function of incident angle to brush pattern. FIG. 7 illustrates the spectrophotometer measurements of graininess (y-axis) at an incident angle to brush pattern of 0°, 45°, and 90° (x-axis) for samples C1, C2, and AA Samples C1 and C2 are reference samples formed using other commercially available approaches. Sample AA formed using methods of the present disclosure. Sample AA has a black finish. Also, sample AA displays higher graininess values than C1 and C2. The graininess may be at least about 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0. The graininess at an incident angle to brush pattern of 0° may be at least about 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0. The graininess at an incident angle to brush pattern of 45° may be at least about 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0. The graininess at an incident angle to brush pattern of 90° may be at least about 2.5, 2.6, 2.7, 2.8, 2.9, 3.0, 3.1, 3.2, 3.3, 3.4, 3.5, 3.6, 3.7, 3.8, 3.9, or 4.0.

The coated substrate may have a greater sparkle grade, a longer detectable sparkle distance ranging from 5 feet (ft) to 65 ft, or 5 ft to 60 ft, or 5 ft to 55 ft, or 5 ft to 50 ft, or 5 ft to 45 ft, or 5 ft to 40 ft, or 5 ft to 35 ft, or 5 ft to 30 ft, or 5 ft to 20 ft, or 5 ft to 15 ft and higher roughness values of the incoming substrate. The high sparkle may be a result of polishing. Smooth surfaces may display shorter detectable sparkle distance. The smooth surfaces may be coated with a black finish. A high roughness on the substrate surface can result in higher sparkle and graininess. The substrate may be coated or uncoated.

Different viewing angles may result in a light change on metallic finishes. The coating on the surface may have a natural flop. Flop can be measured by a tilt in the reflectance of the metallic finish during different viewing angles. The larger the lightness changes between angles of view, the more contours of an object will be accentuated.

In another aspect, the present disclosure provides a system for coating a surface of a stainless steel substrate, comprising: a support configured to hold the stainless steel substrate having the surface and a controller comprising one or more computer processors that are individually or collectively programmed to (i) generate at least one depression in the stainless steel substrate in accordance with a depression pattern, which at least one depression projects into at least a portion of the stainless steel substrate from the surface; (ii) deposit a coating material on at least portion of the surface having the at least one depression; and (iii) cure at least the portion of the surface having the coating material deposited thereon, to provide a coating on the surface having a roughness of Rₐ 7 micro inches (μin) to 200 μin, or 7 μin to 190 μin, or 7 μin to 180 μin, or 7 μin to 170 μin, or 7 μin to 160 μin, or 7 μin to 150 μin, or 7 μin to 140 μin, or 7 μin to 130 μin, or 7 μin to 120 μin, or 7 μin to 110 μin, or 7 μin to 100 μin, or 7 μin to 90 μin, or 7 μin to 80 μin, or 7 μin to 70 μin, or 7 μin to 60 μin, or 7 μin to 50 μin, or 7 μin to 40 μin, or 7 μin to 30 μin, or 7 μin to 20 μin. For example, the surface may have a roughness of at least about 5 μin, at least about 10 μin, at least about 20 μin, at least about 30 μin, at least about 40 μin, at least about 50 μin, at least about 60 μin, at least about 70 μin, at least about 80 μin, at least about 90 μin, at least about 100 μin, at least about 110 μin, at least about 120 μin, or at least about 130 μin. In the system, one or more computer processors may be individually or collectively programmed to cure at least a portion of the surface by subjecting at least the portion of the surface to annealing over an annealing time period of at most about 60 seconds. The annealing time period may be at most about 10 seconds, at most about 20 seconds, at most about 30 seconds, at most about 40 seconds, at most about 50 seconds, at most about 60 seconds, at most about 70 seconds, or at most about 80 seconds.

The annealing may be done at a temperature of at least about 50° F., 100° F., 150° F., 200° F., 300° F., 400° F., 500° F., 600° F., 700° F., 800° F., 900° F. or 1000° F. In the system, one or more computer processors may be individually or collectively programmed to direct polishing of at least a portion of the surface to remove the coating material from at least a portion of the surface.

### Computer Control Systems

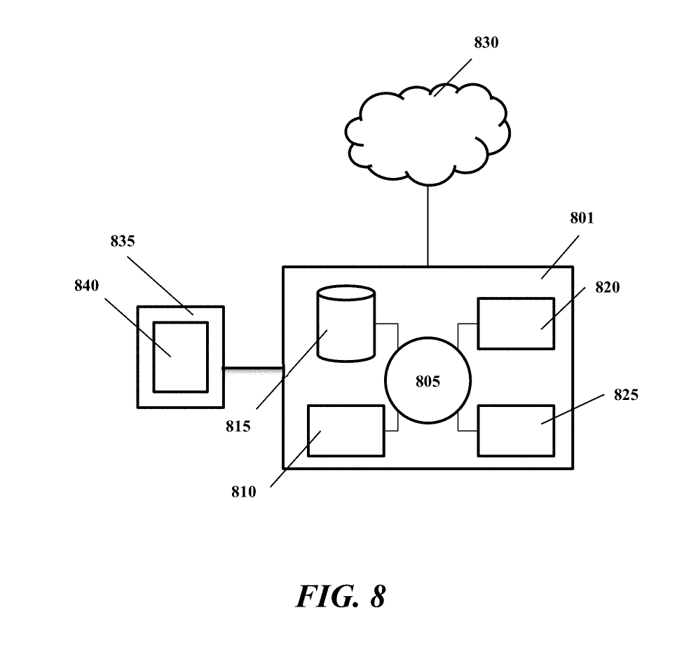

The present disclosure provides computer control systems that are programmed to implement methods of the disclosure. FIG. 8 shows a computer control system 801 that is programmed or otherwise configured to apply a coating to a metal substrate. The computer control system 801 can regulate various aspects of the methods of the present disclosure, such as, for example, methods of generating at least one depression in the stainless steel substrate, depositing a coating material on at least portion of the surface, curing at least the portion of the surface having the coating material, and polishing at least the portion of the surface to remove the coating material from at least a portion of the surface. The computer control system 801 can be implemented on an electronic device of a user or a computer system that is remotely located with respect to the electronic device. The electronic device can be a mobile electronic device.

The computer system 801 includes a central processing unit (CPU, also “processor” and “computer processor” herein) 805, which can be a single core or multi core processor, or a plurality of processors for parallel processing. The computer control system 301 also includes memory or memory location 810 (e.g., random-access memory, read-only memory, flash memory), electronic storage unit 815 (e.g., hard disk), communication interface 320 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer control system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are external to the computer system 801, such as located on a remote server that is in communication with the computer system 801 through an intranet or the Internet.

The computer system 801 can communicate with one or more remote computer systems through the network 830. For instance, the computer system 801 can communicate with a remote computer system of a user (e.g., a user controlling the manufacture of a coated metal substrate). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830.

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software. During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, parameters for producing a slurry and/or applying the slurry to a substrate. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 805. The algorithm can, for example, regulate the generation of least one depression in the stainless steel substrate, the amount of coating added to the metal substrate, the curing process at least the portion of the surface having the coating material, and the polishing process of at least the portion of the surface to remove the coating material from at least a portion of the surface.

### EXAMPLES

### Example 1

In an example, the surface of a stainless steel substrate is coated by providing the stainless steel substrate adjacent to a support, generating at least one depression into at least a portion of a surface of the substrate to yield a texturized surface, depositing a coating material on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 On and 40 On. Next, the coil is painted with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. The painted coil is then annealed with a part metal temperature (PMT) between 360° F. and 400° F., for example 360° F., for less than 60 sec to obtain a dry film thickness (DFT) of 0.20 mils. This coil is then polished with a 400 grit SiC belt at a speed of 150 ft/min and a time of 5 sec to remove paint from the high spots of the substrate. On the finished substrate, about 5% to 20% of the surface is non-painted stainless steel.

### Example 2

In another example, the surface of a stainless steel substrate is coated by providing the stainless steel substrate adjacent to a support, generating at least one depression into at least a portion of a surface of the substrate to yield a texturized surface, split coating on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 On and 40 On. Next, the coil is split coated with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. Next, the first layer is partially annealed at a temperature between 360° F. and 400° F., for example 360° F., to provide a DFT of between 0.08 mils and 0.10 mils of coating. The second layer is then annealed with a PMT between 360° F. and 400° F. to achieve a DFT of between 0.10 mils and 0.12 mils. This coil is then polished with a 400 grit SiC belt at a speed of 150 ft/min and a time of 5 sec to remove paint from the high spots of the substrate. On the finished substrate, about 5% to 20% of the surface is non-painted stainless steel.

### Example 3

In another example, the surface of a stainless steel substrate is coated by providing the stainless steel substrate adjacent to a support, generating at least one depression into at least a portion of a surface of the substrate to yield a texturized surface, depositing a coating material on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is painted with polyester paint (63% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. The painted coil is then annealed with a part metal temperature (PMT) between 360° F. and 400° F., for example 360° F., for less than 60 sec to obtain a dry film thickness (DFT) of between 0.2 mils. This coil is then polished with a 400 grit SiC belt at a speed of 150 ft/min and a time of 5 sec to remove paint from the high spots of the substrate. On the finished substrate, about 5% to 20% of the surface is non-painted stainless steel.

### Example 4

In another example, the surface of a stainless steel substrate is coated by providing the stainless steel substrate adjacent to a support, generating at least one depression into at least a portion of a surface of the substrate to yield a texturized surface, split coating on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is split coated with a polyester paint (63% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. Next, the first layer is partially annealed at a temperature between 360° F. and 400° F., for example 360° F., to provide a DFT of between 0.08 mils and 0.10 mils of coating. The second layer is then annealed with a PMT between 360° F. and 400° F. to achieve a DFT of between 0.10 mils and 0.12 mils. This coil is then polished with a 400 grit SiC belt at a speed of 150 ft/min and a time of 5 sec to remove paint from the high spots of the substrate. On the finished substrate, about 5% to 20% of the surface is non-painted stainless steel.

### Example 5

In another example, the surface of a stainless steel substrate is coated by providing the stainless steel substrate adjacent to a support, generating at least one depression into at least a portion of a surface of the substrate to yield a texturized surface, depositing a coating material on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 On and 40 On. Next, the coil is painted with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. The painted coil is then annealed with a part metal temperature (PMT) between 360° F. and 400° F., for example 360° F., for less than 60 sec to obtain a dry film thickness (DFT) of 0.20 mils. This coil is then polished with a 400 grit SiC belt at a speed of 150 ft/min and a time of 5 sec to remove paint from the high spots of the substrate. After the post paint polish, the coil is subjected to another polishing step with a 400 grit SiC belt at a speed of 150 ft/min and a time of 5 sec to lower the roughness to an Rₐ of less than 20 μin. As a result, the gloss level is raised. On the finished substrate, about 5% to 20% of the surface is non-painted stainless steel.

### Example 6

In another example, the surface of a stainless steel substrate is coated by providing the stainless steel substrate adjacent to a support, generating at least one depression into at least a portion of a surface of the substrate to yield a texturized surface, split coating on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is split coated with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. Next, the first layer is partially annealed at a temperature between 360° F. and 400° F., for example 360° F., to provide a DFT of between 0.08 and 0.10 mils. The second layer is annealed with a PMT between 360° F. and 400° F. to achieve a DFT of between 0.10 and 0.12 mils. This coil is then polished with a 400 grit SiC belt at a speed of 150 ft/min and a time of 5 sec to remove paint from the high spots of the substrate. After the post paint polish, the coil is subjected to another polishing step with a 400 grit SiC belt at a speed of 150 ft/min and a time of 5 sec to lower the roughness to an Rₐ of less than 20 μin. On the finished substrate, about 5% to 20% of the surface is non-painted stainless steel.

### Example 7

In another example, the surface of a stainless steel substrate is coated by providing the stainless steel substrate adjacent to a support, generating at least one depression into at least a portion of a surface of the substrate to yield a texturized surface, depositing a coating material on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is painted with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. The painted coil is then annealed with a part metal temperature (PMT) between 360° F. and 400° F., for example 360° F., for less than 60 sec to obtain a dry film thickness (DFT) increased to 0.30 mils. This coil is then polished with a 400 grit SiC belt at a speed of 150 ft/min and a time of 5 sec to remove paint from the high spots of the substrate. After the post paint polish, the coil is subjected to another polishing step with a 220 grit SiC belt at a speed of 150 ft/min and a time of 5 sec to lower the roughness to an Rₐ of less than 20 μin. As a result, the gloss level is raised. On the finished substrate, about 5% to 20% of the surface is non-painted stainless steel.

### Example 8

In another example, the surface of a stainless steel substrate is coated by providing the stainless steel substrate adjacent to a support, generating at least one depression into at least a portion of a surface of the substrate to yield a texturized surface, split coating on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is split coated with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. Next, the first layer is partially annealed at a temperature between 360° F. and 400° F., for example 360° F. to achieve a DFT of between 0.15 mils of coating. The second layer is annealed with a PMT between 360° F. and 400° F. to achieve a DFT of 0.15 mils. The total DFT is raised to 0.30 mils. This coil is then polished with a 400 grit SiC belt at a speed of 150 ft/min and a time of 5 sec to remove paint from the high spots of the substrate. After the post paint polish, the coil is subjected to another polishing step with a 220 grit SiC belt at a speed of 150 ft/min and a time of 5 sec to lower the roughness to an Rₐ of less than 20 μin. On the finished substrate, about 5% to 20% of the surface is non-painted stainless steel.

### Example 9

In an example, the surface of a stainless steel substrate is coated by providing the stainless steel substrate adjacent to a support, generating at least one depression into at least a portion of a surface of the substrate to yield a texturized surface, depositing a coating material on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is painted with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. The painted coil is then annealed with a part metal temperature (PMT) between 360° F. and 400° F., for example 360° F., for less than 60 sec to obtain a dry film thickness (DFT) of 0.20 mils.

### Example 10

In another example, the surface of a stainless steel substrate is coated by providing the stainless steel substrate adjacent to a support, generating at least one depression into at least a portion of a surface of the substrate to yield a texturized surface, split coating on at least a portion of the texturized surface, curing the coating on the surface, and polishing the portion of the surface to remove the coating material from a least a portion of the surface.

On a mandrel, the stainless steel coil is threaded onto a roll support. A 70 ft stainless steel coil is polished with an abrasive rotating belt concurrently with at least one polishing head. The speed may be 30 ft/min to 130 ft/min, resulting in a roughness of between 30 μin and 40 μin. Next, the coil is split coated with semitransparent urethane paint (20 and 30% solids by volume) via spray painting or roll coating process. During roll coating, the coil passes in an “S” fashion around multiple large rubber coated application rollers and paint is applied onto the sheet. The process of coating is on the order of 5 minutes at a speed between 120 ft/min and 400 ft/min. Next, the first layer is partially annealed at a temperature between 360° F. and 400° F., for example 360° F., to provide a DFT of between 0.08 and 0.10 mils of coating. The second layer is then annealed with a PMT between 360° F. and 400° F. to achieve a DFT of between 0.10 and 0.12 mils.

In some cases, during post-coating applications, a fully formed part is prepared with a surface roughness between 70 μin and 80 μin. The fully formed or shaped substrate is then being coated according to the methods disclosed herein and cured to provide an aesthetic.

### Example 11

Roughness measurements are acquired using a Sterrett SR400 or MahrFederal PocketSurf 4 profilometer. The data is table 1 compares the roughness measurements between a coated door and a stripped door. The coated door consistently has a lower average (ave) Ra, Rz, Rzmax, and Rpc values than the stripped door. The results in table 2 compare the roughness measurements for door coated using methods of the present disclosure, a coated substrate with similar aesthetic, and a coated substrate with visibly less sparkle. As the roughness values increase, there is a noticeable increase in sparkle. The acceptable sparkle aesthetic results from a roughness between 67 μin and 95 μin.

TABLE 1
Roughness Measurements from an Approved Door.

| | Ra | | Rz | | Rzmax | | Rpc | |
|---|---|---|---|---|---|---|---|---|
| | ave | Ra | ave | Rz | ave | Rzmax | ave | Rpc |
| | (μin) | COV | (μin) | COV | (μin) | COV | (ppi) | COV |
| Coated | 48 | 20 | 306 | 22 | 408 | 32 | 157 | 15 |
| Door | | | | | | | | |
| (54 pts) | | | | | | | | |
| Stripped | 95 | 12 | 660 | 12 | 838 | 16 | 334 | 11 |
| Door | | | | | | | | |
| (54 pts) | | | | | | | | |

TABLE 2
Roughness Measurements from an approved door, substrate with
similar aesthetic, and a substrate with visibly less sparkle.

| | Ra | | Rz | | Rzmax | | Rpc | |
|---|---|---|---|---|---|---|---|---|
| | ave | Ra | ave | Rz | ave | Rzmax | ave | Rpc |
| | (μin) | COV | (μin) | COV | (μin) | COV | (ppi) | COV |
| Approved | 95 | 12 | 660 | 12 | 838 | 16 | 334 | 11 |
| Door Sub- | | | | | | | | |
| strate 1 | | | | | | | | |
| Similar | 67 | 5 | 475 | 5 | 577 | 10 | 343 | 10 |
| Aesthetic | | | | | | | | |
| Substrate | | | | | | | | |
| 2 | | | | | | | | |
| Visibly | 51 | 10 | 396 | 7 | 507 | 20 | 277 | 10 |
| Less Spar- | | | | | | | | |
| kle Sub- | | | | | | | | |
| strate 3 | | | | | | | | |

As the roughness values change, there is a noticeable decrease in sparkle.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for forming a stainless steel part, comprising:
(a) providing a substrate comprising stainless steel adjacent to a support, wherein said substrate comprises at least one depression in accordance with a depression pattern, which at least one depression projects into at least a portion of said substrate from a surface of said substrate; and
(b) providing a coating material on at least a portion of said surface having said at least one depression, wherein said coating provides an average roughness (Rₐ) of about 7 micro inches (μin) to 110 On as measured by profilometry and at least any two of (i) a lightness from about 5 to 100 at an incident angle to brush pattern of 90°, (ii) a sparkle intensity from about 1 to 15 at an incident angle to brush pattern of 90°, (iii) a sparkle area from about 5 to 60 at an incident angle to brush pattern of 90°, and (iv) a graininess level from about 2 to 10 as measured by spectrophotometry at a temperature of about 25° C.

2. The method of claim 1, wherein (a) comprises generating said at least one depression in said substrate in accordance with said depression pattern.

3. The method of claim 1, wherein (b) comprises depositing said coating material on said at least said portion of said surface having said at least one depression.

4. The method of claim 1, further comprising (c) curing said at least said portion of said surface having said coating material deposited thereon, to provide said coating on said surface having said roughness from Rₐ 7 μin to 110 μin.

5. The method of claim 1, further comprising, subsequent (b), polishing said at least said portion of said surface to remove said coating material from said at least said portion of said surface.

6. The method of claim 1, wherein said coating provides at least any three of (i)-(iv).

7. The method of claim 1, wherein said substrate comprises an outer stainless steel layer diffusion bonded to an underlying layer.

8. The method of claim 7, wherein said underlying layer comprises carbon.

9. The method of claim 1, wherein said average roughness is from about 30 μin to 110 μin.

10. The method of claim 1, wherein said coating provides a lightness from about 30 to 80 at said incident angle to brush pattern of 90°.

11. The method of claim 1, wherein said coating provides a sparkle intensity from about 5 to 15 at said incident angle to brush pattern of 90°.

12. The method of claim 1, wherein said coating provides a sparkle area from about 20 to 60 at said incident angle to brush pattern of 90°.

13. A stainless steel part, comprising:
a substrate comprising stainless steel, wherein said substrate comprises at least one depression in accordance with a depression pattern, which at least one depression projects into at least a portion of said substrate from a surface of said substrate; and
a coating material on at least portion of said surface having said at least one depression, wherein said coating provides an average roughness (Rₐ) of about 7 micro inches (μin) to 110 μin as measured by profilometry and at least any two of (i) a lightness from about 5 to 100 at an incident angle to brush pattern of 90°, (ii) a sparkle intensity from about 1 to 15 at an incident angle to brush pattern of 90°, (iii) a sparkle area from about 5 to 60 at an incident angle to brush pattern of 90°, and (iv) a graininess level from about 2 to 10 as measured by spectrophotometry at a temperature of about 25° C.

14. The stainless steel part of claim 13, wherein said average roughness is from about 30 μin to 110 μin.

15. The stainless steel part of claim 13, wherein said coating provides a lightness from about 30 to 80 at said incident angle to brush pattern of 90°.

16. The stainless steel part of claim 13, wherein said coating provides a sparkle intensity from about 5 to 15 at said incident angle to brush pattern of 90°.

17. The stainless steel part of claim 13, wherein said coating provides a sparkle area from about 20 to 60 at said incident angle to brush pattern of 90°.

18. The stainless steel part of claim 13, wherein said coating provides at least any three of (i)-(iv).

19. The stainless steel part of claim 13, wherein said substrate comprises an outer stainless steel layer diffusion bonded to an underlying layer.

20. The stainless steel part of claim 19, wherein said underlying layer comprises carbon.
